(19) United States
(12) Patent Application Publication
(10) Pub. No.: US 2010/0039960 A1
(43) Pub. Date: Feb. 18, 2010

(54) Wireless Communication Device, Program, Wireless Communication Method, and Wireless Communication System

(76) Inventor: Shigeru SUGAYA, Kanagawa (JP)

Correspondence Address: FINNEGAN, HENDERSON, FARABOW, GARRETT & DUNNER;LLP, 901 NEW YORK AVENUE, NW, WASHINGTON, DC, 20001-4413, US

(21) Appl. No.: 12/539,439

(22) Filed: Aug. 11, 2009

(30) Foreign Application Priority Data
Aug. 14, 2008 (JP) P2008-208949

(51) Int. Cl. H04L 12/28

(52) U.S. Cl. 370/255

(57) ABSTRACT

A wireless communication device includes: a communication portion that periodically transmits management information for forming a wireless network with at least one wireless communication device, a determination portion that determines, based on one of an attribute and a supply speed of information supplied from a given device, whether to add the information to the management information, and a generation portion that adds the information to the management information according to a determination result of the determination portion.

### BACKGROUND OF THE INVENTION

1. Field of the Invention

The present invention relates to a wireless communication device, a program, a wireless communication method, and a wireless communication system.

2. Description of the Related Art

Various wireless communication systems have been proposed in recent times, and each wireless communication system is used in applications of corresponding communication speed. For example, Bluetooth® is used in audio applications and the like of 1 Mbps or lower, and ZigBee, defined in IEE802.15.4, is used for communication between remote controllers or mouse devices and the controlled device. Wireless local area networks (LANs) are also used for communication of IP data between personal computers (PCs), and ultra-wideband wireless communication systems are used in information communication of 100 Mbps or higher for high-definition video information and the like.

It may therefore become necessary for one wireless communication device to be equipped with a configuration that supports a plurality of wireless communication systems. For example, set-top boxes have needed to be equipped with a configuration supporting both a system for transmitting visual information to a display device and a system for receiving commands for channel selection and the like from a remote controller. Consequently, it is anticipated that wireless communication devices will become larger and more costly.

To deal with these problems, in wireless communication devices equipped with a configuration that supports one wireless communication system, methods for performing communication for a plurality of applications using the wireless communication system have been considered. For example, Japanese Patent Application Publication No. JP-A-2006-238548 describes technology in which a wireless communication device supporting wireless USB forms a wireless USB network with a plurality of wireless communication devices supporting applications such as display devices, digital cameras, or the like, and communicate with one another.

The wireless USB described above is compliant with the WiMedia Distributed MAC specification, and this specification describes a superframe including a beacon period and a data transfer region that is set at a predetermined cycle. Further, according to the specification, when each wireless communication device performs communication in the data transfer region, it makes a communication reservation in the beacon period.

### SUMMARY OF THE INVENTION

However, problems exist in that making a communication reservation within the beacon period may be difficult, and making a communication reservation for the data transfer region on each occurrence of communication data is inefficient.

Accordingly, the present invention addresses the problems described above and provides a wireless communication device, a program, a wireless communication method, and a wireless communication system that are new and improved and that make it possible to transmit information supplied from a given device together with management information (a beacon).

According to an embodiment of the present invention, there is provided a wireless communication device that includes: a communication portion that periodically transmits management information for forming a wireless network with at least one wireless communication device, a determination portion that determines, based on one of an attribute and a supply speed of information supplied from a given device, whether to add the information to the management information, and a generation portion that adds the information to the management information according to a determination result of the determination portion.

The determination portion may determine to add the information supplied from the given device to the management information in a case where the supply speed is less than a specified speed.

The generation portion may write the address of a specific wireless communication device in the information supplied from the given device.

The generation portion may discretely add an error-detection code of the management information and an error-detection code of the information supplied from the given device.

The communication portion may receive from the specific wireless communication device the management information indicating whether correct reception was performed by the specific wireless communication device. In a case where the management information received from the specific wireless communication device by the communication portion indicates that correct reception by the specific wireless communication device was not performed, the generation portion may again add already-sent information supplied from the given device to the management information.

A unit period, including a first period and a second period in which the management information is transmitted by the communication portion, may be periodically repeated. The communication portion may transmit, in the first period, the information supplied from the given device, in a unit period in which the communication portion does not transmit the management information in the second period.

A unit period, including a first period and a second period in which the management information is transmitted by the communication portion, may be periodically repeated. In a case where the communication portion does not transmit the management information in the second period in a specific unit period, the communication portion may transmit the management information to which the information supplied from the given device has been added, in the second period in the unit period following the specific unit period.

The wireless communication device may further include a management portion that manages whether the specific wireless communication device is in an operating state or a hibernating state based on the management information received from the specific wireless communication device by the communication portion. The communication portion may transmit, in a period in which the specific wireless communication device is in an operating state, the management information to which the information supplied from the given device has been added.

The determination portion may determine to add the information supplied from the given device to the management information in a case where an attribute of the information is one of text information, voice information, and audio information.

According to another embodiment of the present invention, there is provided a wireless communication method that includes: a step of periodically transmitting management information for forming a wireless network with at least one wireless communication device, a step of determining, based on one of an attribute and a supply speed of information supplied from a given device, whether to add the information to the management information, and a step of adding the information to the management information according to a result of the determination.

According to another embodiment of the present invention, there is provided a program that causes a computer to function as: a communication portion that periodically transmits management information for forming a wireless network with at least one wireless communication device, a determination portion that determines, based on one of an attribute and a supply speed of information supplied from a given device, whether to add the information to the management information, and a generation portion that adds the information to the management information according to a determination result of the determination portion.

According to another embodiment of the present invention, there is provided a wireless communication system that includes: a plurality of wireless communication devices each having a communication portion that periodically transmits management information for forming a wireless network with at least one wireless communication device, a determination portion that determines, based on one of an attribute and a supply speed of information supplied from a given device, whether to add the information to the management information, and a generation portion that adds the information to the management information according to a determination result of the determination portion.

According to the embodiments of the present invention described above, information supplied from a given device can be transmitted together with management information (a beacon).

### BRIEF DESCRIPTION OF THE DRAWINGS

FIG. 1 is an explanatory diagram showing an example of the configuration of a wireless communication system according to the present embodiment;

FIG. 2 is an explanatory diagram showing an example of the structure of a superframe;

FIG. 3 is a conceptual diagram showing respective beacon slot positions that are set by each wireless communication device for itself;

FIG. 4 is an explanatory diagram showing an example of the configuration of a wireless communication system peripheral to a personal computer;

FIG. 5 is an explanatory diagram showing an example of the configuration of a wireless communication system peripheral to a display device;

FIG. 6A is an explanatory diagram showing an example of the configuration of a wireless communication system peripheral to a stereo system (music playback device);

FIG. 6B is an explanatory diagram showing an example of the configuration of a wireless communication system peripheral to a public-circuit terminal adapter;

FIG. 7 is a sequence diagram showing the flow of bidirectional data transfer in a wireless communication system relating to the present embodiment;

FIG. 8 is a functional block diagram showing the configuration of a wireless communication device according to the present embodiment;

FIG. 9 is an explanatory diagram showing an example of the configuration of beacon slots;

FIG. 10 is an explanatory diagram showing an example of the configuration of a beacon;

FIG. 11 is an explanatory diagram showing an example of the configuration of a beacon data payload;

FIG. 12 is an explanatory diagram showing an example of the configuration of a beacon parameter;

FIG. 13A is an explanatory diagram showing an example of the configuration of a beacon period occupancy information element (BPO IE);

FIG. 13B is an explanatory diagram showing an example of the configuration of a distributed reservation protocol information element (DRP IE);

FIG. 13C is an explanatory diagram showing an example of the configuration of a hibernation mode information element (hibernation mode IE);

FIG. 13D is an explanatory diagram showing an example of the configuration of a hibernation anchor information element (hibernation anchor IE);

FIG. 13E is an explanatory diagram showing an example of the configuration of a traffic indication map information element (TIM IE);

FIG. 14 is an explanatory diagram showing an example of the configuration of a frame check sequence information element (FCS IE);

FIG. 15A is an explanatory diagram showing an example of the configuration of a voice data information element (voice data IE);

FIG. 15B is an explanatory diagram showing an example of the configuration of an audio data information element (audio data IE);

FIG. 15C is an explanatory diagram showing an example of the configuration of a text data information element (text data IE);

FIG. 15D is an explanatory diagram showing an example of the configuration of a program data information element (program data IE);

FIG. 15E is an explanatory diagram showing an example of the configuration of a sensor data information element (sensor data IE);

FIG. 16A is an explanatory diagram showing an example of the configuration of a connection request information element (connection request IE);

FIG. 16B is an explanatory diagram showing an example of the configuration of a connection response information element (connection response IE);

FIG. 16C is an explanatory diagram showing an example of the configuration of a repetition data information element (repetition data IE);

FIG. 17 is a sequence diagram showing a first example of wireless communication performed in the wireless communication system according to the present embodiment;

FIG. 18 is a sequence diagram showing a second example of wireless communication performed in the wireless communication system according to the present embodiment;

FIG. 19A is an explanatory diagram showing operations during a hibernating state relating to the present embodiment;

FIG. 19B is an explanatory diagram showing operations during a hibernating state according to the present embodiment;

FIG. 20A is an explanatory diagram showing ordinary beacon skip operation;

FIG. 20B is an explanatory diagram showing operation during beacon skip operation according to the present embodiment;

FIG. 21 is an explanatory diagram showing other operation during the beacon skip operation according to the present embodiment;

FIG. 22 is a flowchart showing the flow of operation of the wireless communication device according to the present embodiment;

FIG. 23 is a flowchart showing the flow of a data structuring subroutine;

FIG. 24 is an explanatory diagram showing the manner in which a transfer data information element is generated;

FIG. 25 is an explanatory diagram showing the manner in which a transfer data information element, as junction data, is generated; and

FIG. 26 is a flowchart showing the flow of a receipt confirmation subroutine.

### DETAILED DESCRIPTION OF THE PREFERRED EMBODIMENTS

Hereinafter, preferred embodiments of the present invention will be described in detail with reference to the appended drawings. Note that, in this specification and the appended drawings, structural elements that have substantially the same function and structure are denoted with the same reference numerals, and repeated explanation of these structural elements is omitted.

The preferred embodiment for practicing the present invention will be described in the order shown below.

1. Overview of the present embodiment

1-1. Example of the configuration of a wireless communication system

1-2. Time sharing control

1-3. Specific example of application of the wireless communication system

2. Background of the present embodiment

3. Detailed description of a wireless communication device according to the present embodiment

3-1. Configuration of the wireless communication device

(Configuration examples of respective frames and information elements)

3-2. Operation of the wireless communication device

4. Conclusion

1. Overview of the Present Embodiment

1-1. Example of the Configuration of Wireless Communication System

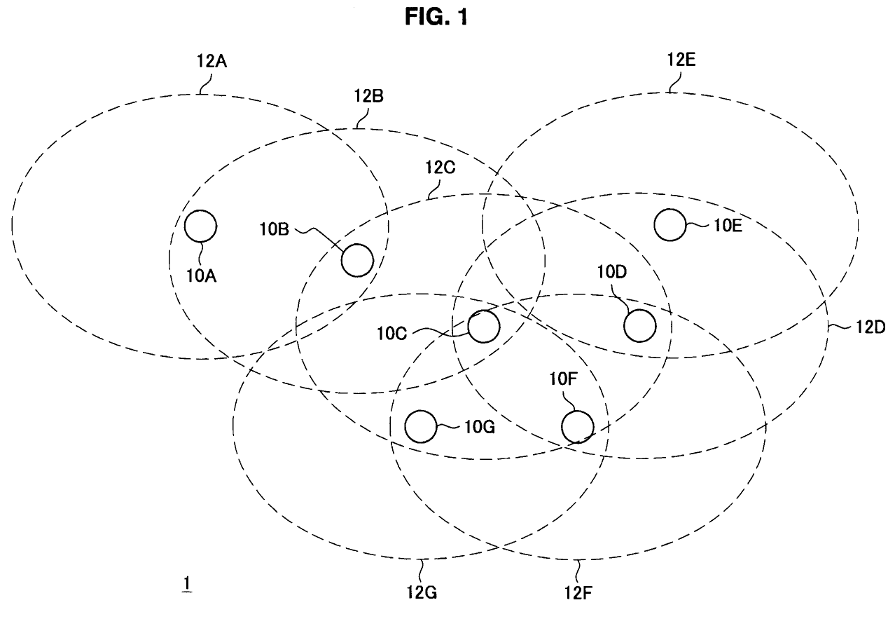

First, an example of the configuration of a wireless communication system 1 according to the present embodiment will be described with reference to FIG. 1.

FIG. 1 is an explanatory diagram showing an example of the configuration of the wireless communication system 1 according to the present embodiment. Circles in FIG. 1 show wireless communication devices 10A to 10G Areas denoted by dotted lines show radio wave reachable ranges 12A to 12G in which the respective wireless communication devices 10A to 10G can perform communication.

More specifically, the wireless communication device 10A can communicate with the wireless communication device 10B that is included in the radio wave reachable range 12A of the wireless communication device 10A. The wireless communication device 10B can communicate with the wireless communication devices 10A and 10C that are included in the radio wave reachable range 12B of the wireless communication device 10B. Similarly, the wireless communication device 10C can communicate with the wireless communication devices 10B, 10D, 10F and 10G. The wireless communication device 10D can communicate with the wireless communication devices 10C, 10E and 10F. The wireless communication device 10E can communicate with the wireless communication device 10D.

Further, the wireless communication device 10F can communicate with the wireless communication devices 10C, 10D and 10G that are included in the radio wave reachable range 12F of the wireless communication device 10F. Similarly, the wireless communication device 10G can communicate with the wireless communication devices 10C and 10F.

The above-described wireless communication devices 10A to 10G transmit and receive beacons, which are an example of communication management information, at a predetermined cycle, and form an autonomous distributed wireless network (an ad hoc network). Thus, the wireless communication devices 10A to 10G that form the wireless network can transmit and receive various types of transfer data. The various types of transfer data may include audio data such as music, a lecture, a radio program, or the like, visual data such as a motion picture, a television program, a video program, a photograph, a document, a painting, a diagram, or the like, and any other type of data, such as a game, software, or the like.

Note that, in the description hereinafter, when it is not necessary to specifically distinguish between the wireless communication devices 10A to 10G, the term wireless communication devices 10 alone will be used. Further, when it is not necessary to specifically distinguish between the radio wave reachable ranges 12A to 12G, the term radio wave reachable ranges 12 will be used. Further, FIG. 1 shows the wireless communication system 1 and also shows the wireless network. Therefore, it can be understood that the terms wireless communication system 1 and wireless network can be almost synonymously used. However, generally, the term network indicates a structure including links in addition to nodes (wireless communication devices). Accordingly, it can also be understood that the wireless network is different from the wireless communication system 1 in that the wireless network includes links in addition to the wireless communication devices 10A to 10G.

Each of the wireless communication devices 10 may be any information processing device such as a personal computer (PC), a household image processing device (a DVD recorder, a video deck or the like), a mobile phone, a personal handyphone system (PHS), a mobile music playback device, a mobile image processing device, a personal digital assistant (PDA), a household game console, a mobile game machine, a household appliance, or the like. Each of the wireless communication devices 10 may also be externally connected to or built into any of these information processing devices functioning as an application device.

1-2. Time Sharing Control

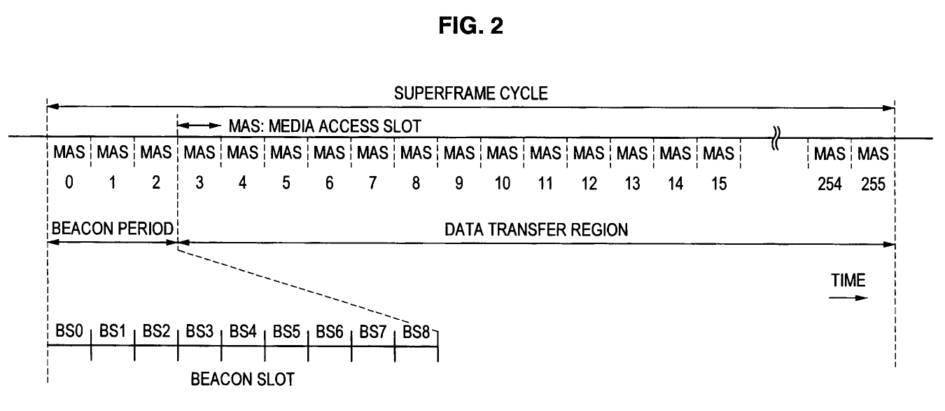

One example of the configuration of the autonomous distributed wireless communication system 1 is described above. Next, a superframe for time sharing control in the wireless communication system 1 will be described with reference to FIG. 2.

FIG. 2 is an explanatory diagram showing an example of the structure of a superframe. The superframe cycle is defined by a predetermined time (for example, 65 ms), and is divided into 256 media access slots (MAS). The wireless communication devices 10 that form one wireless network share the superframe cycle as a specified period frame, and the divided MAS are used as units to transfer messages.

In addition, there is a beacon period (BP, a second period) that serves as a management domain for transmitting and receiving management information using a beacon (a beacon signal) at the head of the superframe, and beacon slots (BS) are arranged at specified intervals. Each wireless communication device 10 is set with a specified beacon slot, and can exchange parameters for performing network management or access control with the wireless communication devices 10 in the vicinity. FIG. 2 shows an example in which 9 beacon slots are set, namely, BS0 to BS8, as the beacon period. Note that the period (a first period) that is not set as the beacon period is normally used as a data transfer region.

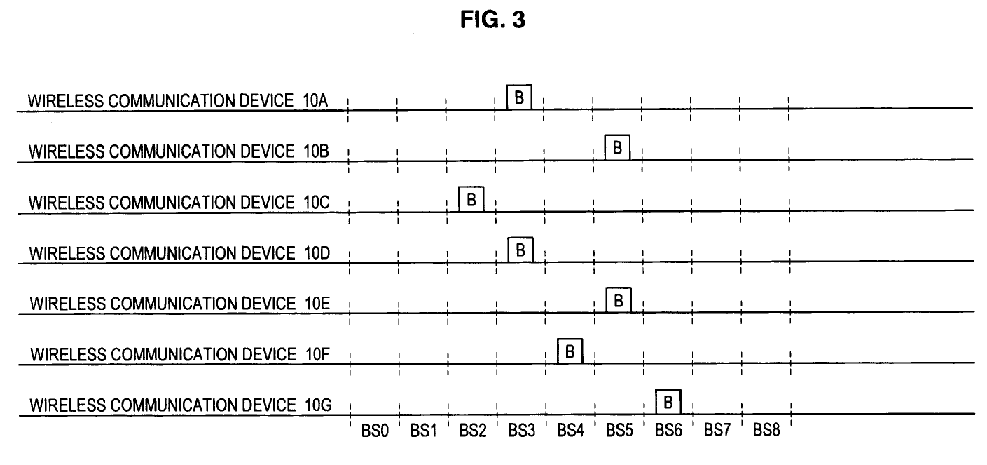

FIG. 3 is a conceptual diagram showing beacon slot positions that are set by each wireless communication device 10 for itself in the case that the wireless communication device 10A to the wireless communication device 10G form one wireless communication system. FIG. 3 shows a state where, after all of the wireless communication devices 10 that form one wireless communication system 1 have notified each other about unoccupied beacon slots, each wireless communication device 10 has selected the beacon slot it is going to use.

In the example shown in FIG. 3, the wireless communication device 10A transmits its beacon using BS3, and the wireless communication device 10B transmits its beacon using BS5. Similarly, the wireless communication device 10C transmits its beacon using BS2, and the wireless communication device 10D transmits its beacon using BS3. The wireless communication device 10E transmits its beacon using BS5. Further, the wireless communication device 10F transmits its beacon using BS4, and the wireless communication device 10G transmits its beacon using BS6.

In the example shown in FIG. 3, the wireless communication device 10A and the wireless communication device 10D share use of the shared BS3, and the wireless communication device 10B and the wireless communication device 10E share use of the shared BS5. However, the wireless communication device 10A and the wireless communication device 10D are away from each other by 3 hops or more, and the wireless communication device 10B and the wireless communication device 10E are also away from each other by 3 hops or more. Therefore, it is assumed that a plurality of wireless communication devices can use the shared BS without any practical problem.

Note that in order that a wireless communication device can newly join the wireless communication system 1, BS0, BS1, BS7, and BS8 can be reserved as necessary. Normally, a specified number of free beacon slots are provided after the beacon slot of each wireless communication device 10. The free beacon slots are provided in case a wireless communication device newly joins the wireless communication system 1.

1-3. Specific Example of Application of the Wireless Communication System

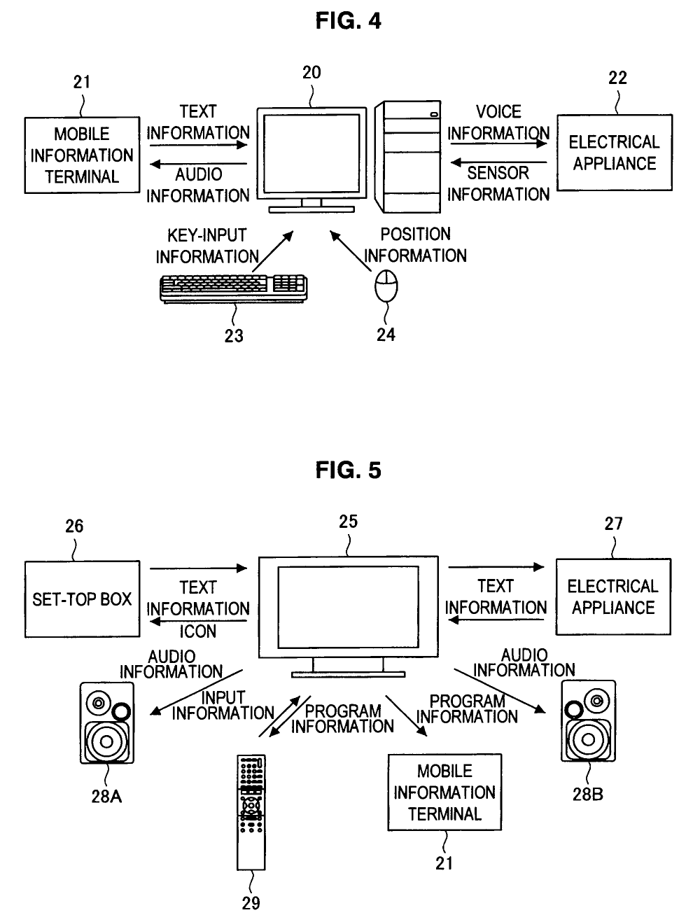

Next, a more specific example of application of the wireless communication system will be described with reference to FIG. 4 through FIG. 6.

FIG. 4 is an explanatory diagram showing an example of the configuration of a wireless communication system peripheral to a PC 20. More specifically, FIG. 4 depicts an example in which the PC 20, a mobile information terminal 21, an electrical appliance 22, a keyboard 23, and a mouse device 24 that are functioning as wireless communication devices 10 together form a wireless network.

In the example shown in FIG. 4, as will be described in detail later, exchanging a small quantity of transfer data by using beacons is possible. For example, text information, audio information, and the like are exchanged between the PC 20 and the mobile information terminal 21, and simple voice information and sensor information are exchanged between the PC 20 and the electrical appliance 22. Key-input information is exchanged between the PC 20 and the keyboard 23, and movement information for the mouse device 24 is exchanged between the PC 20 and the mouse device 24.

FIG. 5 is an explanatory diagram showing an example of the configuration of a wireless communication system peripheral to a display device 25. More specifically, FIG. 5 depicts an example in which the display device 25, a set-top box 26, an electrical appliance 27, speakers 28A and 28B, a remote controller 29, and the mobile information terminal 21 that are functioning as the wireless communication devices 10 form a wireless network.

In the example shown in FIG. 5 as well, similarly, as will be described in detail later, exchanging a small quantity of transfer data by using beacons is possible. For example, text information, icon information, and the like for a program are exchanged between the display device 25 and the set-top box 26, simple text information is exchanged between the display device 25 and the electrical appliance 27, and audio information and the like is exchanged between the display device 25 and the speakers 28A and 28B. Input information and program information are exchanged between the display device 25 and the remote controller 29, and program information and the like is exchanged between the display device 25 and the mobile information terminal 21.

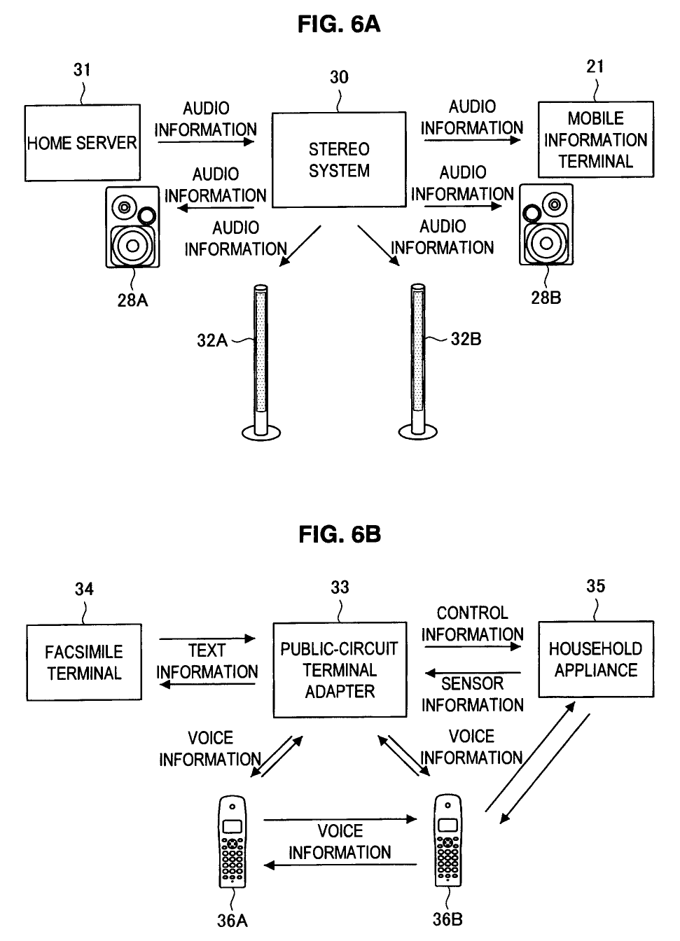

FIG. 6A is an explanatory diagram showing an example of the configuration of a wireless communication system peripheral to a stereo system 30 (music playback device). More specifically, FIG. 6A depicts an example in which the stereo system 30, a home server 31, the speakers 28A and 28B, rear speakers 32A and 32B, and the mobile information terminal 21 that are functioning as the wireless communication devices 10 severally form a wireless network.

In the example shown in FIG. 6A as well, similarly, as will be described in detail later, exchanging a small quantity of transfer data by using beacons is possible. For example, audio information is exchanged between the stereo system 30 and the home server 31, and audio information is exchanged between the stereo system 30 and the mobile information terminal 21. Audio information is exchanged between the stereo system 30 and the speakers 28A and 28B, and audio information is exchanged between the stereo system 30 and the rear speakers 32A and 32B as well.

FIG. 6B is an explanatory diagram showing an example of the configuration of a wireless communication system peripheral to a public-circuit terminal adapter 33. More specifically, FIG. 6B depicts an example in which the public-circuit terminal adapter 33, a facsimile terminal 34, a household appliance 35, and cordless telephone terminals 36A and 36B that are functioning as the wireless communication devices 10 together form a wireless network.

In the example shown in FIG. 6B as well, similarly, as will be described in detail later, exchanging a small quantity of transfer data by using beacons is possible. For example, text information is exchanged between the public-circuit terminal adapter 33 and the facsimile terminal 34, and control information and sensor information are exchanged between the public-circuit terminal adapter 33 and the household appliance 35. Voice information is exchanged between the public-circuit terminal adapter 33 and the cordless telephone terminal 36A, between the public-circuit terminal adapter 33 and the cordless telephone terminal 36B, and between the cordless telephone terminal 36A and the cordless telephone terminal 36B. Also, monitor images, sensor information, and the like are exchanged between the household appliance 35 and the cordless telephone terminal 36B.

2. Background of the Present Embodiment

The present embodiment is described above in outline form with reference to FIG. 1 through FIG. 6. Next, the background of the present embodiment will be described.

In the WiMedia Multiband OFDM Physical Layer (PHY) specification, the physical layer of a ultra-wideband wireless communication system is defined, and more specifically, a communication method using a physical-layer rate of 53.3 Mbps to 480 Mbps is defined.

In the WiMedia Distributed MAC specification, setting a superframe including a beacon period and a data transfer region by a specified cycle is described. In the specification, a method is defined in which management information necessary to maintain the network, such as information on the connection relations between a device itself and wireless communication devices in the vicinity, is exchanged in each beacon period.

Further, in the specification, best-effort communication by prioritized contention access (PCA) control and reservation-control communication assuring QoS by distributed reservation protocol (DRP) control are defined as communication in a data transfer region.

On the other hand, although wireless communication systems principally aimed at high-speed transmission of application data have been defined as described above, low-speed data communication may become necessary, depending on the application device connected to the wireless communication device. For example, although an enormous amount of information may become necessary in data communication from a set-top box to a display device, transmissions from a remote controller to a set-top box are merely of single commands.

Accordingly, wireless communication systems of various standards have been proposed, and the respective wireless communication systems are implemented in applications according to the communication speed. For example, systems employing Bluetooth and systems that perform low power-consumption operation such as ZigBee defined by the IEEE802.15.4 specification are known as systems supporting communication speeds of 1 Mbps or lower. Moreover, wireless communication systems that achieve ultra-high-speed transmission, such as ultra-wideband wireless communication systems, are known as systems supporting communication speeds of 100 Mbps or higher.

However, the need may arise to equip one wireless communication device with a configuration for supporting a plurality of wireless communication systems, and problems of increased cost and size of the wireless communication device have been anticipated. For example, set-top boxes have needed to be equipped with a configuration supporting both a system for transmitting video information to a display device and a system for receiving commands for channel selection and the like from a remote controller.

In addition, amid advancing downsizing of wireless communication devices, some wireless communication devices are provided with antennas for each system, and so the surfaces of the wireless communication devices are covered by antennas. Moreover, it has been necessary to mount filters that are more expensive than necessary on the wireless communication device to avoid mutual interference between the systems, which has become a factor in increased cost.

In a case where a wireless communication system were to be configured from application devices of differing communication speeds, stable data transmission would be achieved by each wireless communication device reserving a specific slot in the data transfer region. However, although this sort of reservation communication is suited to continuously transmitting enormous amounts of data of several Mbps, it has been inefficient in cases where a single command is transmitted suddenly or in cases where a several-second quantity of voice information or other such small quantity of data is transmitted. Further, in a case where a reserved slot is distant from a beacon period, two initiations may be necessary for one superframe, and so low power-consumption operation is difficult to achieve.

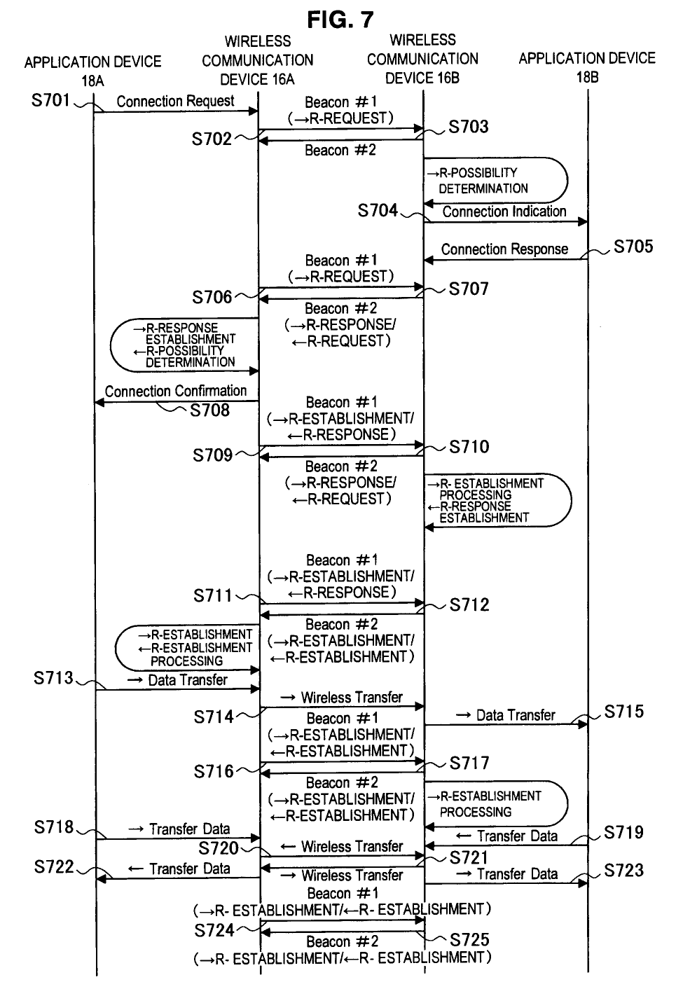

Here, the flow of bidirectional data transfer in a wireless communication system relating to the present embodiment will be described with reference to FIG. 7.

FIG. 7 is a sequence diagram showing the flow of bidirectional data transfer in a wireless communication system relating to the present embodiment. More specifically, FIG. 7 depicts a data transfer sequence between, on one hand, a wireless communication device 16A and an application device 18A connected thereto, and on the other hand, a wireless communication device 16B and an application device 18B connected thereto.

Firstly, a connection request is supplied from the application device 18A to the wireless communication device 16A (step S701). Based on the connection request, the wireless communication device 16A then adds a reservation request for the transfer band to a beacon and transmits it to the wireless communication device 16B connected to the application device 18B that is the destination (step S702). Note that beacon exchange between the wireless communication devices 16A and 16B is performed repeatedly at a predetermined cycle, and so a beacon is transmitted from the wireless communication device 16B substantially simultaneously with transmission of a beacon from the wireless communication device 16A (step S703).

Then, the wireless communication device 16B, along with determining whether reservation according to the reservation request from the wireless communication device 16A is possible, passes a connection indication to the application device 18B (step S704). Note that in FIG. 7, right-pointing arrows are attached to processing and information relating to reservation from the wireless communication device 16A toward the wireless communication device 16B, and left-pointing arrows are attached to processing and information relating to reservation from the wireless communication device 16B toward the wireless communication device 16A.

The application device 18B performs processing for a connection indication 704, and returns a connection response with respect to the connection to the wireless communication device 16B (step S705). At this time, the wireless communication device 16A continues to transmit a beacon to which a reservation request has been added, similarly to step S702 (step S706). On the other hand, when the wireless communication device 16B receives the connection response from the application device 18B, the wireless communication device 16B adds to a beacon a reservation request with respect to that communication and a reservation response with respect to the reservation request received from the wireless communication device 16A at step S702 and transmits the beacon (step S707).

The wireless communication device 16A, based on the beacon including the reservation response to its own reservation request and the new reservation request, performs reservation establishment with respect to the reservation response from the wireless communication device 16B and determines whether a new reservation is possible. Further, the wireless communication device 16A passes a connection confirmation (step S708).

Thereafter, the wireless communication device 16A adds to a beacon the reservation establishment with respect to the reservation response from the wireless communication device 16B and a reservation response with respect to the new reservation request and transmits the beacon (step S709). Note that the wireless communication device 16B continues to transmit a beacon to which information has been added similarly to step S707 (step S710).

When the wireless communication device 16B receives the beacon transmitted from the wireless communication device 16A at step S709, the wireless communication device 16B performs reservation establishment processing for the reservation request from the wireless communication device 16A, and establishes its own reservation request. The wireless communication device 16B adds the reservation establishments in both directions to a beacon and transmits the beacon (step S712), and the wireless communication device 16A establishes the reservations in both directions based on the beacon, and performs the setting of transmission at a transmission reservation slot and the setting of reception at a reception reservation slot.

Thereafter, the wireless communication device 16A becomes able to acquire transfer data from the application device 18A (step S713) and transmits the transfer data at the transmission reservation slot (step S714).

The wireless communication device 16B receives the transfer data from the wireless communication device 16A at the reception reservation slot, and passes the received transfer data to the application device 18B (step S715).

On the other hand, the wireless communication device 16A as well, together with the wireless communication device 16B, enters a state in which a completely bidirectional transfer route has been successfully set by adding reservation establishments in two directions to a beacon 716 (steps S716 and S717). That is to say, the wireless communication device 16B as well performs the setting of transmission at the transmission reservation slot and the setting of reception at the reception reservation slot by receiving, at step S716, the beacon to which the reservation establishments in two directions have been added.

Next, the wireless communication device 16A acquires transfer data from the application device 18A (step S718), and transmits (Wireless Transfer) the transfer data at the transmission reservation slot (step S720). The wireless communication device 16B acquires transfer data from the application device 18B (step S719), and transmits (Wireless Transfer) the transfer data at the transmission reservation slot (step S721).

The wireless communication device 16A, having received the transfer data at step S721, passes the transfer data to the application device 18A (step S722). Further, the wireless communication device 16B, having received the transfer data at step S720, passes the transfer data to the application device 18B (step S723). As long as this data transfer is continued, bidirectional reservation establishments continue to be added to the beacons of the wireless communication device 16A (step S724), and bidirectional reservation establishments continue to be added also to the beacons of the wireless communication device 16B (step S725).

In this manner, in the wireless communication system relating to the present embodiment, communication reservation is performed using a beacon for transmission of transfer data. However, as was described above, performing communication reservation using a beacon at each transmission of voice information or text information having a small information quantity may sometimes be inefficient.

Note that in actual data transfer, a method of communication by using PCA immediately after the beacon period had been considered, but when a plurality of wireless communication devices perform communication by using PCA all at once, communication contention may sometimes occur. Further, because the length of this beacon period differs depending on the arrangement of each wireless communication device and the wireless communication devices in the vicinity thereof, even when the wireless communication device on the transmission side recognized that the beacon period has expired, the wireless communication device at the receiving destination may recognize the beacon period as existing. Consequently, even when the wireless communication device on the transmission side has performed data transmission immediately after the expiration of the beacon period, a case may occur in which the wireless communication device on the receiving side is in the beacon period. In this case, the wireless communication device on the receiving side may be unable to acknowledge data receipt.

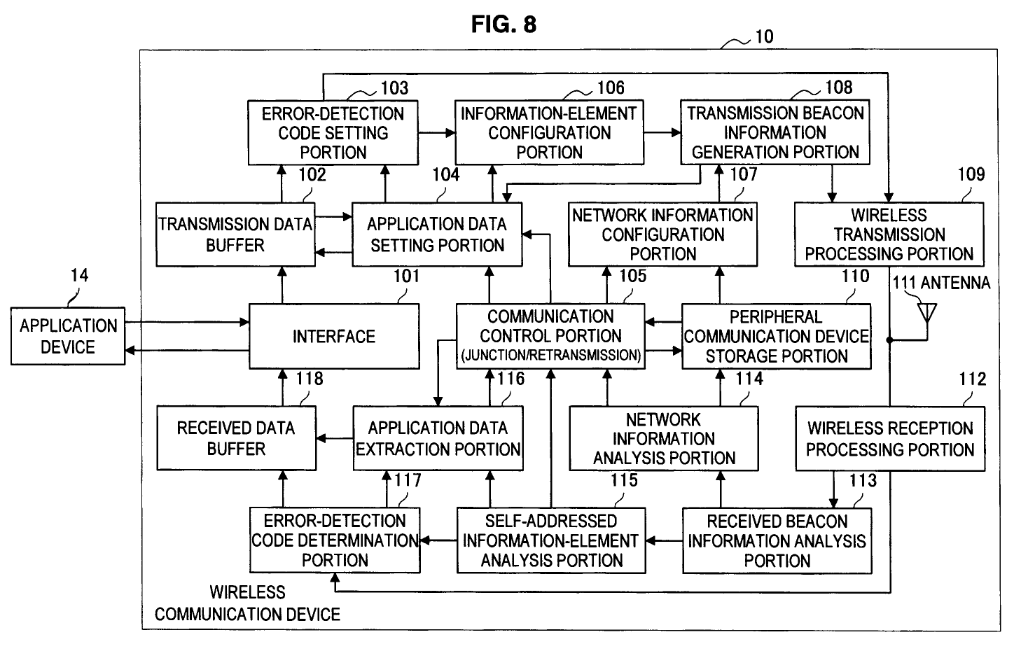

Accordingly, in light of the above-described circumstances, the wireless communication device 10 according to the present embodiment has been created. According to the wireless communication device 10 of the present embodiment, information supplied from an application device can be added to a beacon and transmitted. Hereinafter, the wireless communication device 10 will be described with reference to FIG. 8 through FIG. 16.

3. Detailed Description of a Wireless Communication Device According to the Present Embodiment

3-1. Configuration of the Wireless Communication Device

FIG. 8 is a functional block diagram showing the configuration of the wireless communication device 10 according to the present embodiment. As shown in FIG. 8, the wireless communication device 10 is provided with an interface 101, a transmission data buffer 102, an error-detection code setting portion 103, an application data setting portion 104, a communication control portion 105, an information-element configuration portion 106, a network information configuration portion 107, a transmission beacon information generation portion 108, a wireless transmission processing portion 109, a peripheral communication device storage portion 110, an antenna 111, a wireless reception processing portion 112, a received beacon information analysis portion 113, a network information analysis portion 114, a self-addressed information-element analysis portion 115, an application data extraction portion 116, an error-detection code determination portion 117, and a received data buffer 118.

The interface 101 inputs and outputs any given application data between itself and an application device 14 that executes an application. For example, the interface 101 is supplied with transmission-use transfer data (application data) from the application device 14. Note that the transfer data may include commands (operation instruction information) for content playback, pause, fast-forward, rewind, volume-level adjustment, selection, and the like. Further, the interface 101 outputs transfer data stored in the received data buffer 118 to the application device 14.

The transmission data buffer 102 temporarily stores transfer data supplied from the application device 14 via the interface 101.

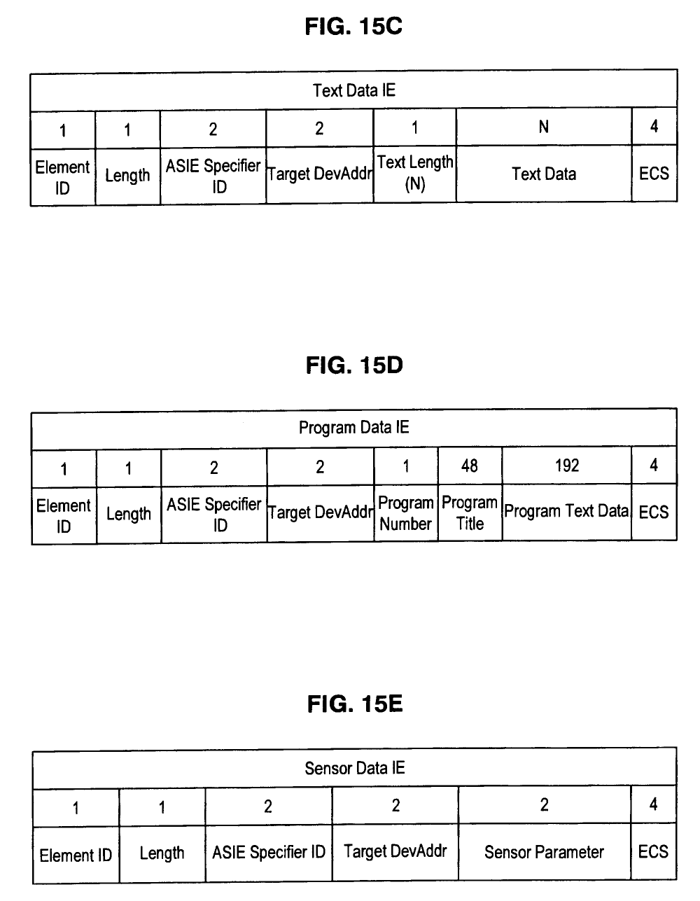

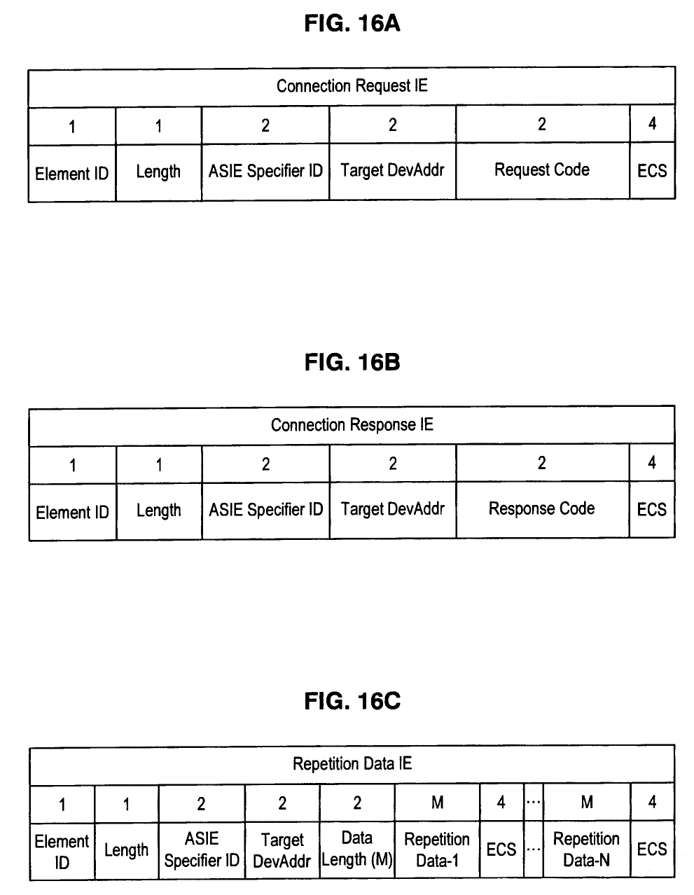

In a case where the application data setting portion 104 has determined that addition of the transfer data to the beacon is possible, the error-detection code setting portion 103 sets, as required, an error-detection code for each predetermined data quantity of the transfer data stored in the transmission data buffer 102. Specifically, the error-detection code setting portion 103 sets the ECS shown in FIG. 15A through FIG. 15E or each ECS shown in FIG. 16C.

The application data setting portion 104 functions as a determination portion that determines whether addition of the transfer data supplied from the application device 14 to the beacon is possible. For example, the application data setting portion 104 monitors the supply speed of the transfer data from the application device 14, and in a case where the supply speed is lower than the transmissible transmission speed because of addition to the beacon, may determine that addition of the transfer data to the beacon is possible.

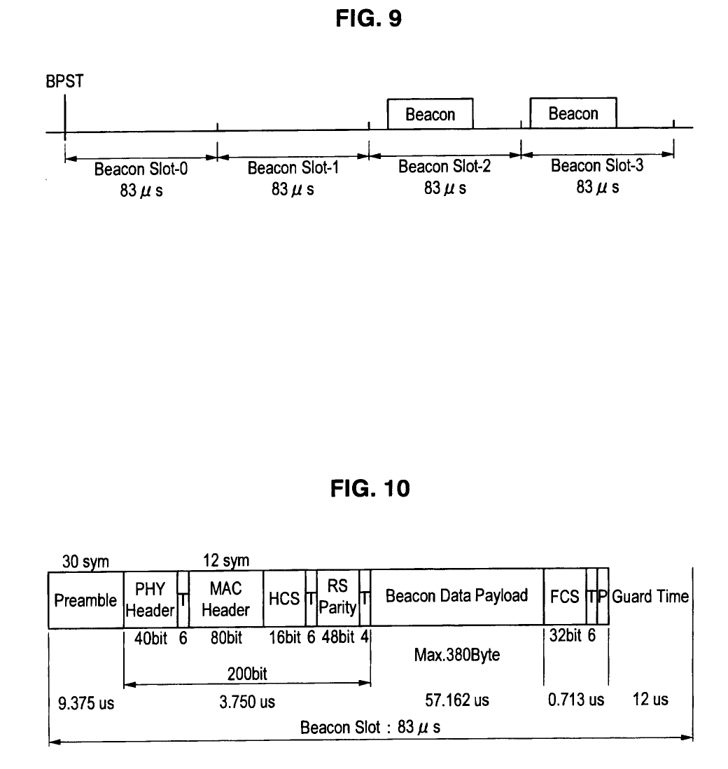

FIG. 9 is an explanatory diagram showing an example of the configuration of beacon slots. As shown in FIG. 9, each beacon slot during the beacon period is configured at approximately 83 μs, and the beacons are transmitted in such a way that they fit into the respective beacon slots.

FIG. 10 is an explanatory diagram showing an example of the configuration of a beacon. More specifically, FIG. 10 shows the relation of the configuration of a beacon transmitted and received by the beacons slot (approximately 83 μs) and maximum frame length.

As shown in FIG. 10, a preamble functioning as a synchronization signal and corresponding to 30 symbols (9.375 μs) is added before the beacon. The beacon includes, as header information, a PHY header (40 bits), a MAC header (80 bits), a header check sequence (HCS; 16 bits), and a Reed-Solomon parity (RS parity code; 48 bits), with tail bits (T; 6 bits or 4 bits) interposed in the respective intervals therebetween, and is configured to be a total of 200 bits, the equivalent of 12 symbols (3.75 μs).

Further, a time totaling 57.162 μs, obtained by excluding a guard time, frame check sequence (FCS; 32 bits), tail bits (T; 6 bits), and, as required, padding (P; 0.713 μs) from the end of the beacon slot, can be used for transfer of a beacon data payload. Thus, it is estimated that approximately 380 bytes of data can be added as the beacon data payload. Further, because a superframe cycle is approximately 65,536 μs, the transmission speed of data by using the beacon data payload is estimated to be approximately 5.799 kbytes/s.

In this case, the application data setting portion 104 may determine that addition of the transfer data to the beacon is possible in a case where the supply speed of the transfer data from the application device 14 is lower than 5.799 kbytes/s. The application data setting portion 104 may also determine whether addition of the transfer data to the beacon is possible on a basis of whether the supply speed of the transfer data from the application device 14 is lower than a pre-set supply speed. Further, comparison of speed to the supply speed of the transfer data from the application device 14 may be modified by a type of modulation or a type of encoding of the beacon.

Moreover, the application data setting portion 104 may determine whether addition of the transfer data to the beacon is possible according to an attribute (media class) of the transfer data supplied from the application device 14. For example, cases where the supply speed of video data exceeds the transmission speed by the beacon data payload are conceivable, but the supply speed of text data, voice data, or audio data, for which the amount of data is comparatively small, is considered to be lower than the above-described transmission speed in many cases. Accordingly, in a case where the transfer data supplied from the application device 14 is text data, voice data, or audio data, the application data setting portion 104 may determine that addition of the transfer data to the beacon is possible.

The communication control portion 105 controls all operations of the wireless communication device 10, such as addition of the transfer data to the beacon, setting of junction data, and the like. The communication control portion 105 also controls, based on description of a beacon slot information bitmap included in the beacon received from a wireless communication device in the vicinity, retransmission of transfer data previously added to a beacon and transmitted. Further, the communication control portion 105 performs control of beacon skip, hibernation mode, and the like.

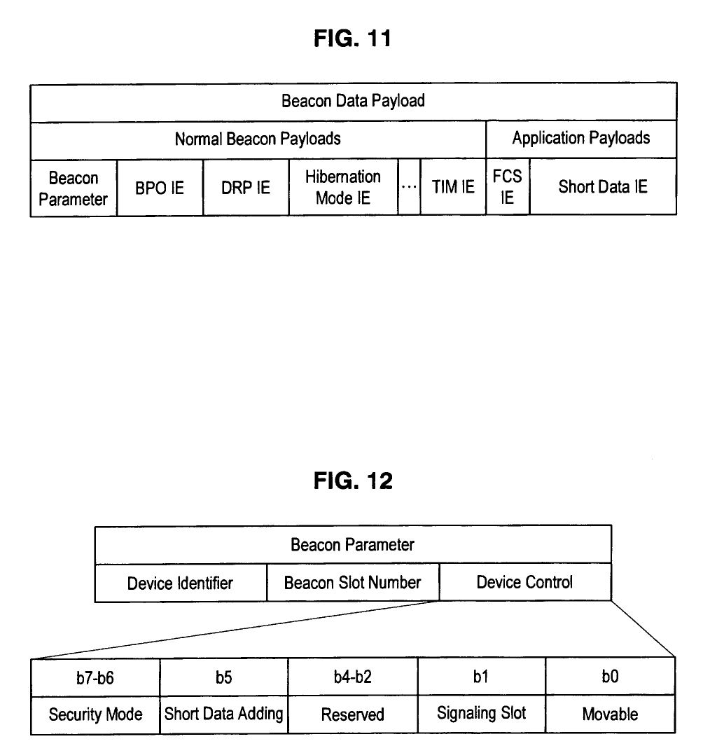

The information-element configuration portion 106 generates each type of information element for addition to the beacon. The transmission beacon information generation portion 108 functions as a generation portion for generating beacons that include information elements generated by the information-element configuration portion 106. Here, an information element may include transfer data supplied from the application device 14 in addition to management information for the wireless communication device 10 to form a wireless network with at least one wireless communication device in the vicinity. Hereinafter, the configuration of beacon payloads and of various information elements will be described with reference to FIG. 11 through FIG. 16C.

FIG. 11 is an explanatory diagram showing an example of the configuration of the beacon data payload. As shown in FIG. 11, the beacon data payload includes a beacon parameter, a beacon period occupancy information element (BPO IE), a distributed reservation protocol information element (DRP IE), a hibernation mode information element (hibernation mode IE), a traffic indication map information element (TIM IE), and various other such types of information elements as normal beacon payloads.

Further, the beacon data payload includes a frame check sequence information element (FCS IE) and a transfer data information element (short data IE) as application payloads.

FIG. 12 is an explanatory diagram showing an example of the configuration of the beacon parameter. As shown in FIG. 12, the beacon parameter includes a device identifier, a beacon slot number, and device control information.

The device control information includes a movable specification (movable), a signaling slot, transfer data adding (short data adding) information, and a security mode. The short data adding information indicates whether the transfer data information element is included in the beacon data payload. Based on the short data adding information, the wireless communication device 10 is able to assess, before decoding the beacon data payload, whether the transfer data information element is included in the beacon data payload.

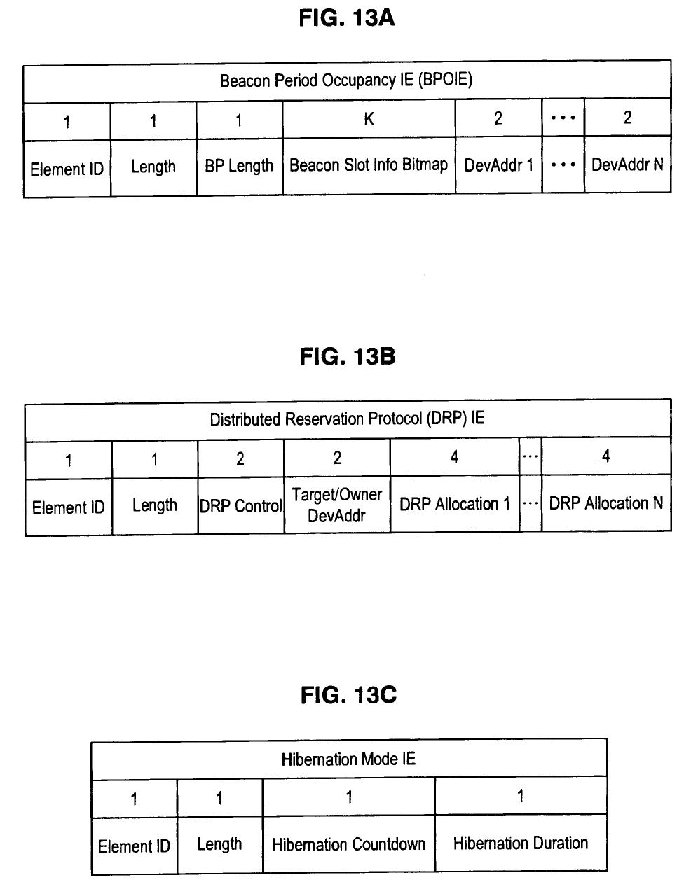

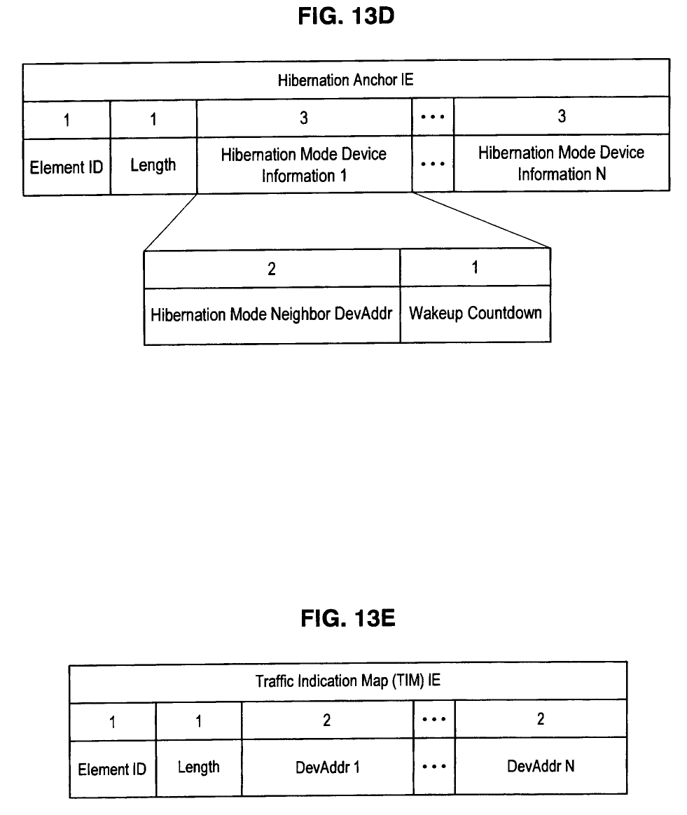

FIG. 13A is an explanatory diagram showing an example of the configuration of the beacon period occupancy information element (BPO IE). As shown in FIG. 13A, the beacon period occupancy information element includes an element ID for identifying the element, an information length (length) indicating the length of this information element, a BP length indicating the length of the beacon period, a beacon slot information bitmap (beacon slot info bitmap) indicating an occupancy state of the beacon slots, and device addresses (DevAddr 1 through DevAddr N).

Here, a beacon reception status of each beacon slot is described in the beacon slot information bitmap. For example, in a case where an error has been detected in both the HCS and the FCS at a certain beacon slot despite a beacon having been received, “10” is described, and a broadcast address (BcstAddr=0xFFFF) is described at the device address. In a case where no error exists in the HCS and an error is detected in the FCS, “10” is described, and the address of the wireless communication device corresponding to the device address is described. Further, in a case where the HCS and the FCS are both correct, “01” or “11” is described, and the address of the wireless communication device corresponding to the device address is described. When a preamble portion of the signal is not detected in the beacon slot, “00” is described, and no device address is described.

FIG. 13B is an explanatory diagram showing an example of the configuration of the distributed reservation protocol information element (DRP IE). As shown in FIG. 13B, the distributed reservation protocol information element includes an element ID for identifying the element, an information length (length) indicating the length of this information element, control information (DRP control) of a DRP reservation, an address (target/owner DevAddr) of a reservation counterpart, and DRP allocation position information (DRP allocation 1 through DRP allocation N).

FIG. 13C is an explanatory diagram showing an example of the configuration of the hibernation mode information element (hibernation mode IE). As shown in FIG. 13C, the hibernation mode information element includes an element ID for identifying the element, an information length (length) indicating the length of this information element, a hibernation countdown value (hibernation countdown) until entry into hibernation operation, and a value (hibernation duration) of the period during which hibernation operation is performed.

FIG. 13D is an explanatory diagram showing an example of the configuration of a hibernation anchor information element (hibernation anchor IE). As shown in FIG. 13D, the hibernation anchor information element includes an element ID for identifying the element, an information length (length) indicating the length of this information element, and hibernation mode device information 1 through hibernation mode device information N.

Further, this hibernation mode device information 1 through N includes an address (hibernation mode neighbor DevAddr) of a device in the hibernation mode and a wakeup countdown value (wakeup countdown).

FIG. 13E is an explanatory diagram showing an example of the configuration of the traffic indication map information element (TIM IE). As shown in FIG. 13E, the traffic indication map information element includes an element ID for identifying the element, an information length (length) indicating the length of this information element, and device addresses (DevAddr 1 through DevAddr N) of wireless communication devices having transmission traffic.

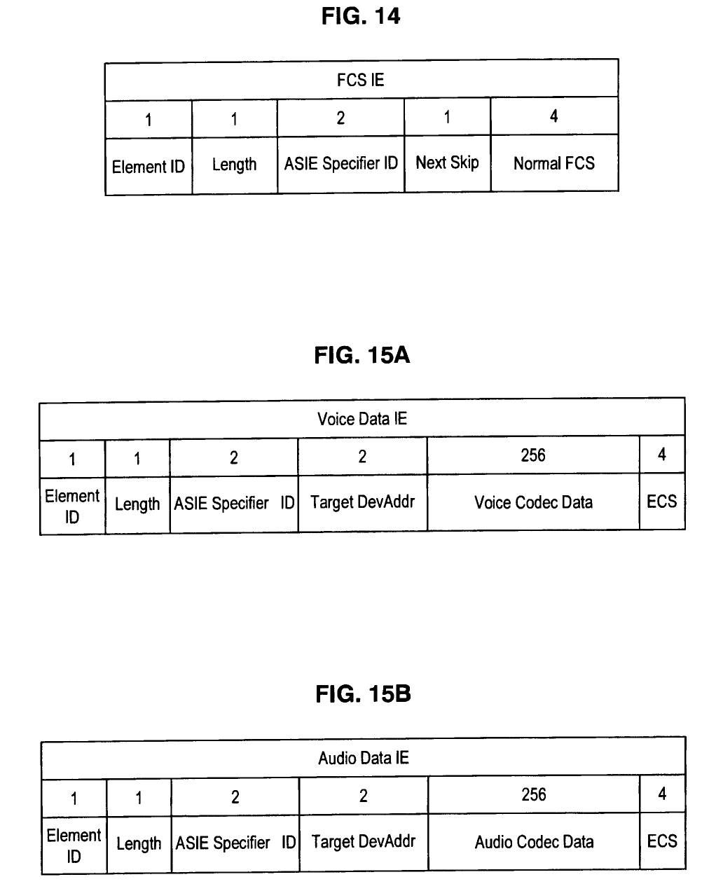

FIG. 14 is an explanatory diagram showing an example of the configuration of the frame check sequence information element (FCS IE). As shown in FIG. 14, the frame check sequence information element includes an element ID for identifying the element, an information length (length) indicating the length of this information element, an application specification information element specifier identifier (ASIE specifier ID), a next skip for making notification that the next beacon will be skipped, and a frame check sequence (normal FCS) for detecting an error of the portion up to here.

FIG. 15A through FIG. 15E are explanatory diagrams showing specific examples of the transfer data information elements. For example, FIG. 15A, shows an example of the configuration of a voice data information element (voice data IE).

As shown in FIG. 15A, the voice data information element includes an element ID for identifying the element, an information length (length) indicating the length of this information element, an application specification information element specifier identifier (ASIE specifier ID), a target device address (target DevAddr), voice codec data, and a frame check sequence (ECS) of the voice data information element. In this voice data information element, the voice codec data corresponds to transfer data supplied from the application device 14.

FIG. 15B shows an example of the configuration of an audio data information element (audio data IE). As shown in FIG. 15B, the audio data information element includes an element ID for identifying the element, an information length (length) indicating the length of this information element, an application specification information element specifier identifier (ASIE specifier ID), a target device address (target DevAddr), audio codec data, and a frame check sequence (ECS) of the audio data information element. In this audio data information element, the audio codec data corresponds to transfer data supplied from the application device 14.

FIG. 15C shows an example of the configuration of a text data information element (text data IE). As shown in FIG. 15C, the text data information element includes an element ID for identifying the element, an information length (length) indicating the length of this information element, an application specification information element specifier identifier (ASIE specifier ID), a target device address (target DevAddr), a text length indicating the number of characters included in succeeding text data, text data, and a frame check sequence (ECS) of the text data information element. In this text data information element, the text data corresponds to transfer data supplied from the application device 14.

FIG. 15D shows an example of the configuration of a program data information element (program data IE). As shown in FIG. 15D, the program data information element includes an element ID for identifying the element, an information length (length) indicating the length of this information element, an application specification information element specifier identifier (ASIE specifier ID), a target device address (target DevAddr), a program number, a program title, program text data, and a frame check sequence (ECS) of the program data information element. In this program data information element, the program number, program title, and program text data correspond to transfer data supplied from the application device 14.

FIG. 15E shows an example of the configuration of a sensor data information element (sensor data IE). As shown in FIG. 15E, the sensor data information element includes an element ID for identifying the element, an information length (length) indicating the length of this information element, an application specification information element specifier identifier (ASIE specifier ID), a target device address (target DevAddr), a sensor data (sensor parameter), and a frame check sequence (ECS) of the sensor data information element. In this sensor data information element, the sensor data corresponds to transfer data supplied from the application device 14.

In this manner, each of the transfer data information elements includes a target device address that identifies the wireless communication device of the transmission target. Consequently, the wireless communication device can selectively receive transfer data included in a transfer data information element in which the target device address is its own address. On the other hand, a receiving destination device, in a case where a transfer data information element in which the target device address is its own address is not added, does not necessarily have to receive the transfer data information element.

Here, the frame check sequence (FCS) added after the beacon is an error-detection code corresponding to the entire content of the beacon, and so if a portion of the transfer data information elements is not received, error detection using the FCS cannot be performed properly. However, in the present embodiment, the frame check sequence information element shown in FIG. 14 is added as an error-detection code corresponding to an ordinary beacon payload other than a transfer data information element. Therefore, according to the present embodiment, the receiving destination device can, even in a case where a portion of the transfer data information elements is not received, properly perform error detection of an ordinary beacon payload on a basis of the frame check sequence information element. Note that in this case, the receiving destination device does not necessarily have to perform error detection on a basis of the frame check sequence (FCS) added after the beacon.

FIG. 16A is an explanatory diagram showing an example of the configuration of a connection request information element (connection request IE). The wireless communication device 10, in order to reserve transmission of a transfer data information element to another wireless communication device, adds the connection request information element to a beacon. More specifically, the connection request information element includes an element ID for identifying the element, an information length (length) indicating the length of this information element, an application specification information element specifier identifier (ASIE specifier ID), a target device address (target DevAddr), a request code, and a frame check sequence (ECS) of the connection request information element.

FIG. 16B is an explanatory diagram showing an example of the configuration of a connection response information element (connection response IE). The wireless communication device 10, in order to respond to a connection request information element received from another wireless communication device, adds the connection response information element to a beacon. More specifically, the connection response information element includes an element ID for identifying the element, an information length (length) indicating the length of this information element, an application specification information element specifier identifier (ASIE specifier ID), a target device address (target DevAddr), a response code, and a frame check sequence (ECS) of the connection response information element.

FIG. 16C is an explanatory diagram showing an example of the configuration of a repetition data information element (repetition data IE). The repetition data information element includes a plurality of combinations of transfer data (repetition data) and an error-detection code of the transfer data segmented at each instance of a predetermined data quantity.

More specifically, the repetition data information element includes an element ID for identifying the element, an information length (length) indicating the length of this information element, an application specification information element specifier identifier (ASIE specifier ID), a target device address (target DevAddr), a data length (M) of a succeeding one piece of repetition data, repetition data-1 having a data length of M, a frame check sequence (ECS) that is an error-detection code of the repetition data-1, . . . , a repetition data-N, and a frame check sequence (ECS) that is an error-detection code of the repetition data-N.

Note that it is possible for the configuration of the repetition data information element shown in FIG. 16C to be applied to the configuration of each of the transfer data information elements shown in FIG. 15A through FIG. 15E.

The wireless transmission processing portion 109 performs signal processing on a beacon generated by the transmission beacon information generation portion 108, converting it to high-frequency signals. The wireless transmission processing portion 109 also performs signal processing on data for transmission during a data transfer period, converting it to high-frequency signals. The antenna 111 is an interface with wireless communication devices in the vicinity, and functions as a transmission portion, receiving portion, or communication portion that transmits or receives beacons or data respectively to or from wireless communication devices in the vicinity.

The wireless reception processing portion 112 performs signal processing on the high-frequency signals received by the antenna 111, performing demodulation of the beacons or data. The received beacon information analysis portion 113 analyzes parameters included in the beacons demodulated by the wireless reception processing portion 112. For example, the received beacon information analysis portion 113 may perform error detection based on the HCS or FCS included in the beacons.

The network information analysis portion 114 analyzes, based on the parameters included in the beacons, information of other wireless communication devices existing in the vicinity. For example, the network information analysis portion 114 functions as a management portion that analyzes whether another wireless communication device is occupying any beacon slot, has reserved any MAS, is hibernating, or the like. The peripheral communication device storage portion 110 stores the information analyzed by the network information analysis portion 114.

Here, assume that the wireless communication device 10 has transmitted a beacon having a transfer data information element added thereto and targeting a specific wireless communication device, in a specific beacon slot. In response to this, the specific wireless communication device transmits a beacon including a BPO IE describing whether the beacon was received properly at the specific beacon slot.

Accordingly, the communication control portion 105 can determine, based on the description of the BPO IE of the beacon received from the specific wireless communication device, whether the beacon transmitted by the wireless communication device 10 was received properly by the specific wireless communication device. Further, in a case where the communication control portion 105 determines that the beacon transmitted by the wireless communication device 10 was not received properly, the communication control portion 105 causes the application data setting portion 104 to retransmit a beacon including the previously transmitted transfer data information element.

In this manner, the communication control portion 105 can determine whether the beacon arrived properly based on the description of the BPO IE, and so data transfer of high reliability can be achieved while excluding ACKs for reception of the beacon.

The self-addressed information-element analysis portion 115 extracts any self-addressed information elements from the information elements included in the beacon data payload. Further, the application data extraction portion 116 extracts transfer data information elements from the self-addressed information elements.

The error-detection code determination portion 117, based on the ECS included in the transfer data information elements depicted in FIG. 15A through FIG. 15E, performs error detection of the transfer data information elements. The payload portion of a transfer data information element in which no error was detected is stored in the received data buffer 118, and thereafter is output to the application device 14 via the interface 101.

Further, the error-detection code determination portion 117, in a case where the transfer data information element is configured with repetitions shown in FIG. 16C, performs error detection of each repetition data based on the ECS added to each repetition data. Repetition data in which no error was detected is stored in the received data buffer 118, and thereafter is output to the application device 14 via the interface 101. Moreover, the wireless communication device 10 may transmit a beacon including retransmission request information of repetition data in which an error was detected. With this configuration, when an error is present in a transfer data information element, only the portion having the error is retransmitted, and so the amount of communication data can be kept small.

3-2. Operation of the Wireless Communication Device

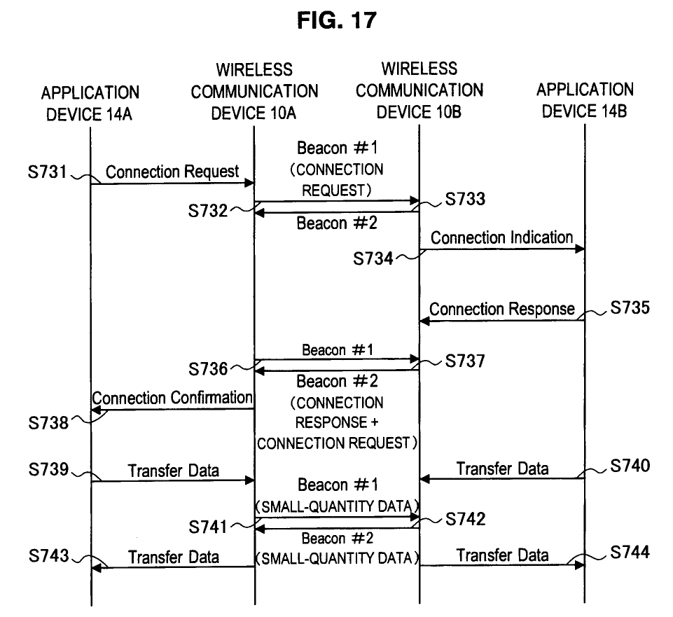

The configuration of the wireless communication device 10 according to the present embodiment has been described above. Next, a wireless communication method of the present embodiment will be described with reference to FIG. 17 through FIG. 26.

FIG. 17 is a sequence diagram showing a first example of wireless communication performed in the wireless communication system 1 according to the present embodiment. More specifically, FIG. 17 depicts the flow of wireless communication between a wireless communication device 10A and an application device 14A connected thereto on the one hand and a wireless communication device 10B and an application device 14B connected thereto on the other hand.

Firstly, a connection request is supplied from the application device 14A to the wireless communication device 10A (step S731). After that, the wireless communication device 10A, based on the connection request 731, adds the connection request shown in FIG. 16A to the beacon and transmits the beacon to the wireless communication device 10B connected to the application device 14B that is the destination (step S732). Note that beacon exchange is performed repeatedly in a predetermined cycle, and the wireless communication device 10B as well transmits a beacon substantially simultaneously (step S733).

Then, the wireless communication device 10B, based on the connection request information element included in the received beacon, along with determining whether reservation is possible, passes a connection indication to the application device 14B (step S734). The application device 14B performs processing for the connection indication, and returns a connection response with respect to the connection (step S735).

At this time, the wireless communication device 10A continues to transmit a beacon to which the connection request information element has been added, similarly to step S732 (step S736). Further, the wireless communication device 10B adds to a beacon the connection request information element based on the response received from the application device 14B and the connection response information element with respect to the connection request information element received from the wireless communication device 10A and transmits the beacon (step S737).

The wireless communication device 10A, based on the connection response information element in response to its own connection request information element included in the received beacon, performs establishment of the reservation. Further, the wireless communication device 10A determines whether the reservation is possible, based on the connection request information element from the wireless communication device 10B that is included in the received beacon. Further, the wireless communication device 10A passes a connection confirmation to the application device 14A (step S738). After this, both the application device 14A and the application device 14B have established a connected state, and exchange of transfer data employing beacons becomes possible. Note that although description thereof in FIG. 17 is omitted, the wireless communication device 10A may transmit the connection response information element in response to the connection request information element from the wireless communication device 10B.

After that, the wireless communication device 10A acquires transfer data sent from the application device 14A (step S739), and adds the transfer data as a transfer data information element to a beacon and transmits the beacon (step S741). Similarly, the wireless communication device 10B acquires transfer data sent from the application device 14B (step S740), and adds the transfer data as a transfer data information element to a beacon and transmits the beacon (step S742).

Further, the wireless communication device 10A, having received the beacon to which the transfer data information element was added, passes the transfer data included in the transfer data information element to the application device 14A (step S743). Similarly, the wireless communication device 10B, having received the beacon to which the transfer data information element was added, passes the transfer data included in the transfer data information element to the application device 14B (step S743).

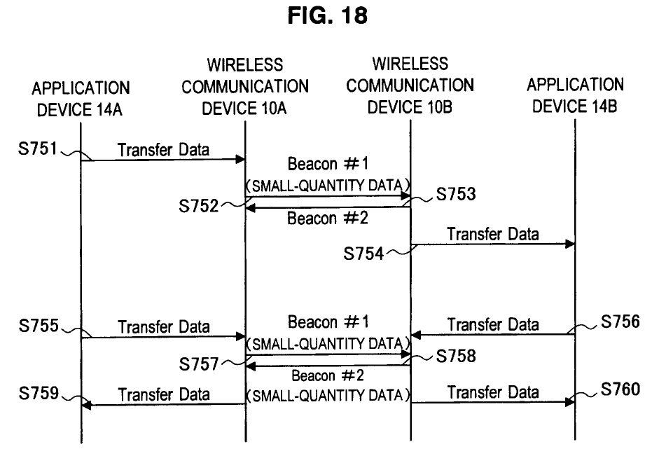

FIG. 18 is a sequence diagram showing a second example of wireless communication performed in the wireless communication system 1 according to the present embodiment. More specifically, FIG. 18 depicts the flow of wireless communication between the wireless communication device 10A and the application device 14A connected thereto on the one hand and the wireless communication device 10B and the application device 14B connected thereto on the other hand. A point in which the second example differs from the first example is that the transfer data is exchanged without passing through an exchange process of the connection request information element and the connection response information element.

More specifically, firstly, the wireless communication device 10A acquires transfer data sent from the application device 14A to the application device 14B (step S751). Then, the wireless communication device 10A identifies the wireless communication device 10B connected to the application device 14B, generates a transfer data information element addressed to the wireless communication device 10B, and adds the transfer data information element to a beacon and transmits the beacon (step S752). Note that because beacon exchange is performed repeatedly at a predetermined cycle, the wireless communication device 10B as well transmits a beacon substantially simultaneously (step S753).

After that, the wireless communication device 10B extracts the transfer data information element from the received beacon, and passes the transfer data included in the transfer data information element to the application device 14B as received data (transfer data) (step S754). Similarly, the wireless communication device 10A acquires the transfer data sent from the application device 14A (step S755), and generates a transfer data information element, adds the transfer data information element to a beacon, and transmits the beacon (step S757).

Further, the wireless communication device 10B acquires the transfer data sent from the application device 14B (step S756), and generates a transfer data information element, adds the transfer data information element to a beacon, and transmits the beacon (step S758). In addition, the wireless communication device 10A, having received the beacon to which the transfer data information element was added, passes the transfer data included in the transfer data information element to the application device 14A as received data (transfer data) (step S759). Similarly, the wireless communication device 10B, having received the beacon to which the transfer data information element was added, passes the transfer data included in the transfer data information element to the application device 14B as received data (transfer data) (step S760).

In this manner, according to the present embodiment, a beacon slot reserved in advance as the device's own transmission time slot is used, and so there is effectiveness with respect to a point that complex communication reservation processing for using a data transfer region becomes unnecessary.

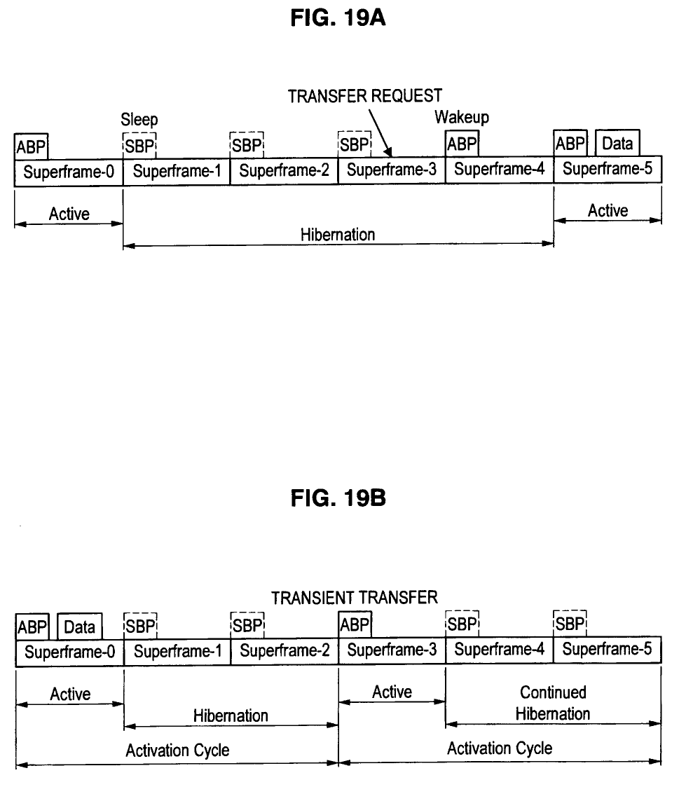

Next, operations during a hibernating state and operations during a beacon skip will be described with reference to FIG. 19 through FIG. 21.

FIG. 19A is an explanatory diagram showing operations during a hibernating state relating to the present embodiment. As shown in FIG. 19A, the wireless communication device relating to the present embodiment, on stopping to perform data transfer, adds the hibernation mode information element to a beacon and transmits the beacon in a beacon period (ABP) of a superframe (superframe-0) in operation. The wireless communication device relating to the present embodiment then enters a hibernating state for subsequent superframes (superframe-1 through -3) and does not perform beacon transmission in a beacon period (SBP).

After that, when a transfer request is generated (superframe-3), a transition from the hibernating state to an operating state occurs at the next superframe (superframe-4), and a beacon announcing activation is transmitted in the beacon period (ABP). Then, data transfer is performed in the subsequent superframe (superframe-5).

In this manner, the wireless communication device relating to the present embodiment had to maintain an operating state for at least a plurality of superframes in order to perform data transfer. In contrast to this, the wireless communication device 10 according to the present embodiment can reduce the time that an operating state is maintained, as shown in FIG. 19B.

FIG. 19B is an explanatory diagram showing operations during a hibernating state according to the present embodiment. In the example shown in FIG. 19B, the wireless communication device 10 determines in advance a cycle (active cycle) in which an operating state is entered, and exchanges beacons in accordance with that cycle.

More specifically, the wireless communication device 10 performs transmission and reception of beacons in the beacon period (ABP) of the superframe (superframe-0) in operation, and performs data transfer reserved in a data transfer region. After that, the wireless communication device 10 enters a hibernating state (superframe-1 through -2) until the cycle (active cycle) in which the operating state is entered is reached.

The wireless communication device 10, in a case where the superframe (superframe-3) in which the operating state is entered arrives, can transmit and receive, in that beacon period (ABP), beacons to which transfer data information elements have been added. After that, the wireless communication device 10 again enters a hibernating state (superframe-4 through -5) until the cycle (active cycle) in which the operating state is entered is reached.

In this manner, according to the present embodiment, the wireless communication device 10 in a hibernating state may change to an operating state only in the beacon period of the superframe for performing data transfer, and so electrical power consumption can be reduced.

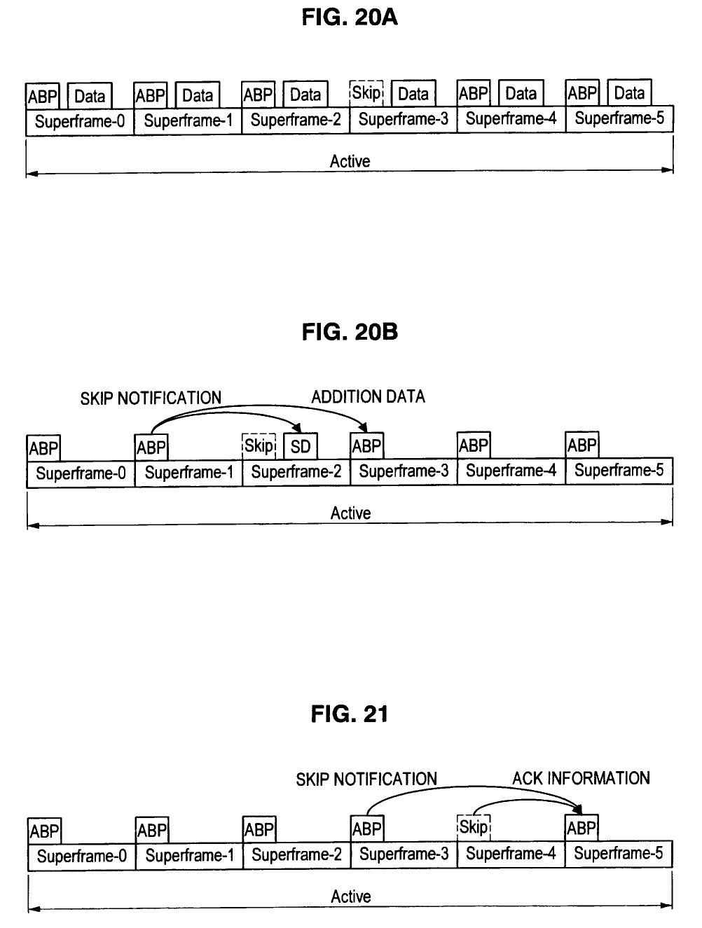

FIG. 20A is an explanatory diagram showing ordinary beacon skip operation. A beacon skip is described in the WiMedia Distributed MAC specification as an operation which skips (does not perform) beacon transmission one time in a predetermined superframe cycle. FIG. 20A shows the manner in which beacon transmission is skipped at superframe-3. Note that even in the superframe cycle (superframe-3) in which beacon transmission is skipped, transmission and reception of data reserved in advance can be performed.

In this manner, a beacon skip is performed one time in the predetermined superframe cycle. Accordingly, when a beacon skip is performed, the wireless communication device 10 according to the present embodiment may execute the operations indicated below.

FIG. 20B is an explanatory diagram showing operation during beacon skip operation according to the present embodiment. As shown in FIG. 20B, in a case where the superframe (superframe-2) at which a beacon skip is to be performed has been determined in advance, the wireless communication device 10 provides notification that the next beacon skip is to be performed by the beacon of the superframe (superframe-1) immediately before. More specifically, the information-element configuration portion 106 may generate a frame check sequence information element in which it is described that the next beacon skip is to be performed at the next skip, and the antenna 111 may transmit the beacon to which the information element has been added.

Then, the communication control portion 105 of the wireless communication device 10, when performing a beacon skip, may perform control so that for example any of the operations indicated below is performed.

(1) Transfer data is transmitted by temporarily using the data transfer region of the superframe cycle (superframe-2) in which the beacon skip was performed.

(2) Transfer data which could not be transmitted in the superframe cycle (superframe-2) in which the beacon skip was performed is added to the beacon of the superframe (superframe-3) following the superframe in which the beacon skip was performed, and is transmitted.

With this configuration, even in a case in which the wireless communication device 10 performs a beacon skip, continuous transmission of transfer data can be maintained.

FIG. 21 is an explanatory diagram showing other operation during the beacon skip operation according to the present embodiment. As was described in “3-1. Configuration of the wireless communication device,” the wireless communication device 10 can use the beacon period occupancy information element to perform transmission of a reception status of a beacon and confirmation of a reception status of a beacon at another wireless communication device.

However, the wireless communication device 10, in a case of performing a beacon skip, cannot perform transmission of the reception status by using the beacon of the superframe (superframe-4) in which the skip was performed. To address this, the wireless communication device 10 additionally describes, in the beacon period occupancy information element of the beacon of the next superframe (superframe-5), the reception status of the beacon (transfer data) that needed to be described in the previous beacon.

That is to say, the reception statuses of the previous and second previous beacons (transfer data information elements) are both described in the beacon period occupancy information element of the beacon of the superframe (superframe-5) following the superframe in which the skip was performed. More specifically, yet another set of a beacon slot information bitmap and device addresses (DevAddr 1 through DevAddr N) may be described in the beacon period occupancy information element depicted in FIG. 13A. With this configuration, the wireless communication device 10 functions as a receiving-side device, and moreover, in a case where a beacon skip is performed, the transmission-side device can continuously confirm the reception status of the beacon (transfer data information element) at the wireless communication device 10.

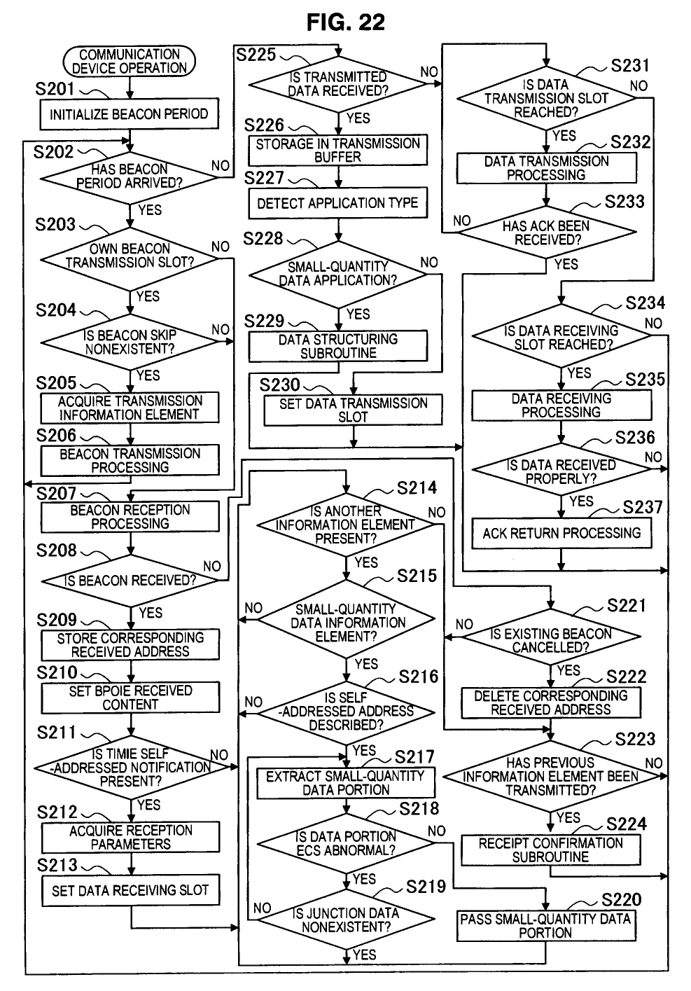

Next, operations of the wireless communication device 10 according to the present embodiment will be described with reference to FIG. 22 through FIG. 26.

FIG. 22 is a flowchart showing the flow of operation of the wireless communication device 10 according to the present embodiment. Firstly, when a power source is turned on for the wireless communication device 10, a channel (TFC code) at which the wireless communication device 10 operates, the beacon period, the beacon slot of the wireless communication device 10, and the superframe cycle are set according to a predetermined algorithm (step S201).

Then, when the beacon period arrives (step S202), the beacon transmission slot is the device's own (step S203), and no beacon skip has been set (step S204), the transmission beacon information generation portion 108 acquires the information elements to be transmitted and generates the beacon (step S205). The wireless communication device 10 then transmits the beacon generated by the transmission beacon information generation portion 108 (step S206).

In a case where the beacon transmission slot is other than the device's own or a beacon skip has been performed, the wireless communication device 10 performs reception processing (step S207). Then the wireless communication device 10, if a beacon is received (step S208), stores the address described in the beacon (step S209), and the information-element configuration portion 106 describes the reception status thereof in the beacon period occupancy information element (BPO IE) (step S210).

Here, if the device's own address (transmission notification) is described in a transmission indication information element (TIM IE) of the received beacon (step S211), the wireless communication device 10 acquires the reception parameters describing the slot (MAS) in which the data is transmitted at that superframe (step S212), and sets the slot as its own data receiving slot (step S213).

If another information element that is a transfer data information element in which the device's own address is described has been added to the beacon (step S214 through step S216), the application data extraction portion 116 extracts the payload portion of the transfer data information element (step S217). If an abnormality is detected by using the frame check sequence (ECS) of the transfer data information element (step S218) and no junction data has been added (step S219), processing of the information element is ended. On the other hand, in a case where junction data has been added, processing returns to step S217, and the payload of the junction data to be repeatedly transmitted is extracted. Further, in a case where no abnormality is detected by using the frame check sequence (ECS) of the transfer data information element, the payload is passed to the application device 14 via the interface 101 (step S220).

If no beacon was received during the course of the predetermined superframe cycle in the beacon slot where the existing beacon was received (step S221), the peripheral communication device storage portion 110 cancels the address of the wireless communication device that was using the beacon slot (step S222).

After processing of all information elements included in the received beacon has been performed, if the wireless communication device 10 has transmitted the previous beacon with a transfer data information element added thereto (step S223), the process proceeds to a subroutine for receipt confirmation (step S224).

Further, if the wireless communication device 10 receives transfer data from the application device 14 via the interface 101 (step S225), the wireless communication device 10 stores the transfer data in the transmission data buffer 102 (step S226). The application data setting portion 104 detects the application type of the transfer data, and if the application type is a specified application (step S228), the process proceeds to a data structuring subroutine (step S229). Note that if the supply speed of the transfer data from the application device 14 is at or below a predetermined speed, the process may proceed to the data structuring subroutine.

On the other hand, if the transfer data is not the specified application, the wireless communication device 10, in order to perform ordinary data transmission, specifies a counterpart device using for example a transmission indication information element or the like, and along with this, makes the setting of the slot for data transmission (step S230). Then, if the slot for the data transmission is reached (step S231), the wireless communication device 10 performs ordinary data transmission processing (step S232). After that, if receipt from the counterpart is (ACK) confirmed (step S233), the process returns to step S202. Note, however, that if the wireless communication device 10 does not receive the receipt confirmation from the counterpart, the process returns to step S231, and processing of retransmission within the range of the data transmission slot is performed.

Further, if the slot for data transmission is reached (step S234), the wireless communication device 10 performs data receiving processing (step S235), and if the data is received properly (step S236), the wireless communication device 10 performs return processing of receipt confirmation (ACK) (step S237). After the wireless communication device 10 performs this set of processing, the process returns to step S202, and the series of operations is repeated.

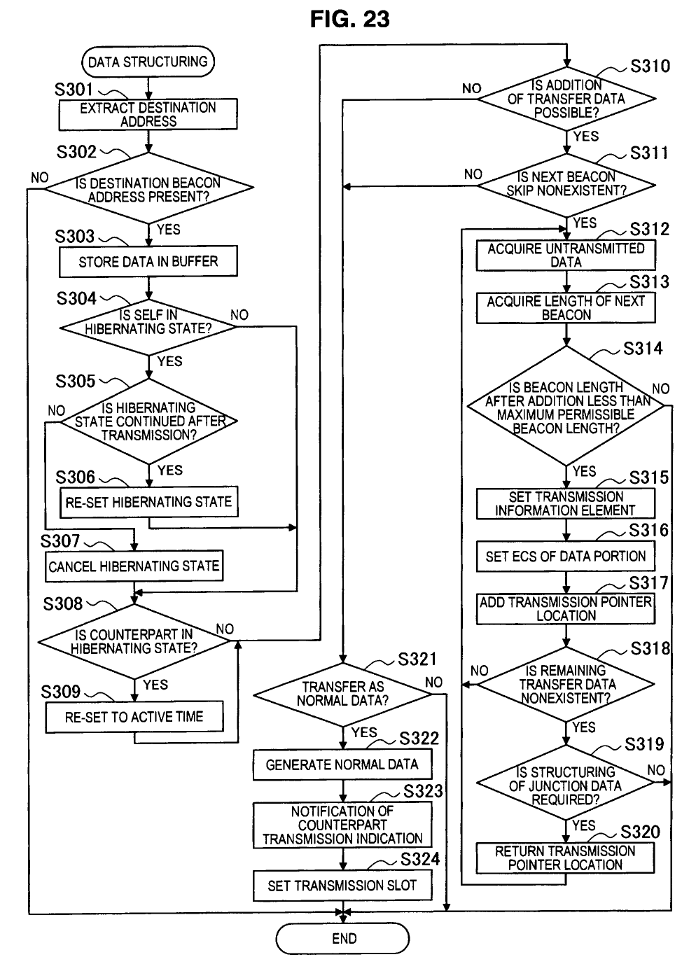

FIG. 23 is a flowchart showing the flow of the data structuring subroutine. Firstly, the wireless communication device 10 extracts the address of the wireless communication device to which the application device that is the destination is connected (step S301). If the beacon slot of the wireless communication device is available (step S302), the wireless communication device 10 stores the transfer data in the transmission buffer (step S303).

Here, if the device itself is in a hibernating state (step S304) and the hibernating state can be continued after data transmission (step S305), re-setting of the hibernating state is performed (step S306). On the other hand, if the data quantity of the transfer data is large and the hibernating state cannot be continued, the wireless communication device 10 performs cancellation of the hibernating state and performs the setting of an always-active operating state (step S307). Further, if the counterpart wireless communication device is in a hibernating state (step S308), the wireless communication device 10 pauses subsequent processing until an operating state is entered (step S309).

Then, if the counterpart wireless communication device is not in a hibernating state and addition of the transfer data information element to the beacon is possible (step S310) and if no beacon skit has been set for the next beacon period (step S311), the wireless communication device 10 acquires untransmitted data (step S312). Further, the transmission beacon information generation portion 108 acquires the next beacon length (step S313), and if the beacon length is less than a maximum permissible beacon length (step S314), sets transmission of the transfer data information element (step S315). The information-element configuration portion 106 then generates a transfer data information element including the frame check sequence (ECS) (step S316).

Further, the wireless communication device 10 adds the location of a transmission pointer of the transmission data buffer 102 (step S317). If untransmitted transfer data remains (step S318), the process returns to step S312, and transfer data information elements of the remaining transfer data are added until the maximum permissible beacon length is reached.

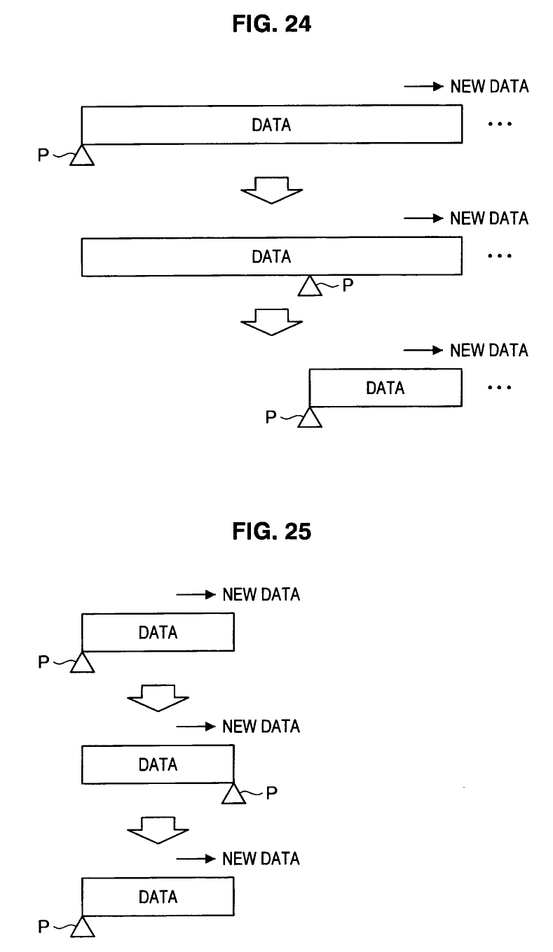

FIG. 24 is an explanatory diagram showing the manner in which a transfer data information element is generated. As shown in FIG. 24, the wireless communication device 10 sequentially acquires the transfer data stored in the transmission data buffer 102 from a location indicated by a transmission pointer P, and, along with generating the transfer data information element, updates the location of the transmission pointer P. Then, when the beacon length of the beacon after addition of the transfer data information element reaches the maximum permissible beacon length (center figure), the wireless communication device 10 transmits the beacon. Note that in a case where the wireless communication device 10 has confirmed, based on for example the beacon period occupancy information element, that the beacon was properly received by the counterpart wireless communication device, the wireless communication device 10 deletes the transfer data prior to the transmission pointer from the transmission data buffer 102 (lower figure).

Returning here to the description of FIG. 23, if no untransmitted transfer data remains (step S318) and if addition of junction data is required (step S319), the wireless communication device 10 returns the location of the transmission pointer (step S320), and the process returns to step S312. That is to say, the wireless communication device 10 adds transfer data information elements that duplicate the transfer data that has already been a transmission target until the maximum permissible beacon length is reached. Further, the wireless communication device 10 ends the data structuring subroutine even in a case where the beacon reaches the maximum permissible beacon length or in a case where addition of junction data is not required.

FIG. 25 is an explanatory diagram showing the manner in which a transfer data information element, as junction data, is generated. As shown in FIG. 25, the wireless communication device 10 sequentially acquires the transfer data stored in the transmission data buffer 102 from a location indicated by the transmission pointer P, and, along with generating the transfer data information element, updates the location of the transmission pointer P. Then, if remaining transfer data is used up before the beacon length of the beacon after addition of the transfer data information element reaches the maximum permissible beacon length (center figure), the wireless communication device 10 returns the location of the transmission pointer P to the start of the transmission data buffer 102 (lower figure). The wireless communication device 10 then generates transfer data information elements that duplicate the transfer data that has already been a transmission target until the maximum permissible beacon length is reached. In this manner, by redundantly transmitting transfer data information elements including identical transfer data, even in a case where an error exists in one transfer data information element, accurate transfer data can be acquired from another transfer data information element.

Returning here to the description of FIG. 23, if the wireless communication device 10 cannot add a transfer data information element, or if a beacon skip will be performed in the next beacon period, the wireless communication device 10 determines whether to transmit the transfer data using the data transfer region as normal data (step S321). Then, in a case of transmission as normal data, the wireless communication device 10 generates a data frame as normal data (step S322) and specifies the counterpart wireless communication device by a transmission indication information element (TIM IE) of the device itself (step S323). Further, the wireless communication device 10 specifies a slot (MAS) for transmission as required (step S324).

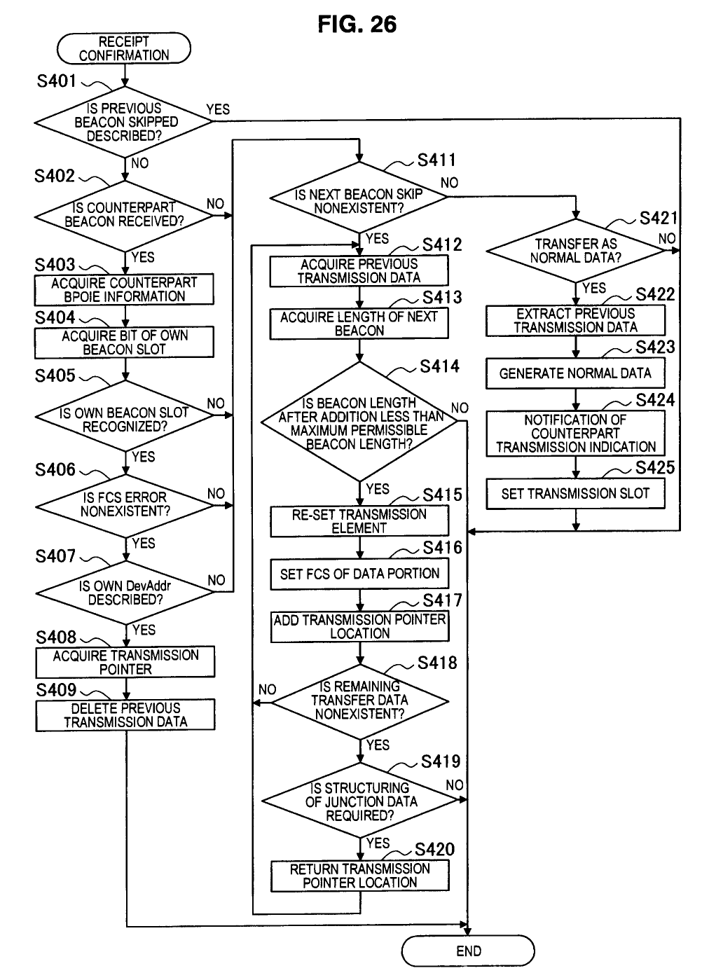

FIG. 26 is a flowchart showing the flow of a receipt confirmation subroutine. Firstly, if the wireless communication device 10 performed a beacon skip in the previous beacon period (step S401), the beacon transmitted from the counterpart wireless communication device is not updated properly with the reception status, and so processing is ended.

On the other hand, if a beacon from the counterpart wireless communication device has been received (step S402), the wireless communication device 10 acquires the beacon period occupancy information element (BPO IE) from the beacon (step S403) and acquires a bit corresponding to the device's own beacon slot (step S404).

If a value indicating that the device's own existence was recognized properly (that no error was present in the HCS or FCS) is described in the bit (step S405), if no error is present in the frame check sequence (FCS) (step S406), and if the device's own device address (DevAddr) is described, the wireless communication device 10 acquires the location of the transmission pointer and deletes the transfer data prior to the transmission pointer from the transmission data buffer 102 (step S409).

On the one hand, in a case where no beacon is received from the counterpart wireless communication device, in a case where the counterpart does not properly recognize the device's own beacon, in a case where an error is present in the FCS, or in a case where the device's own DevAddr is not described, the processing which will be described below is performed. That is to say, if the wireless communication device 10 does not perform a beacon skip in the next beacon period (step S411), the wireless communication device 10 returns the transmission pointer to the start of the transmission data buffer 102 and acquires the previously transmitted transfer data (step S412), and acquires the beacon length of the next beacon (step S413). Then, if the beacon length thereof is less than the maximum permissible beacon length (step S414), the wireless communication device 10 re-sets transmission of the transfer data information element including the previously transmitted transfer data (step S415). The information-element configuration portion 106 then generates a transfer data information element including the previously transmitted transfer data and the frame check sequence (ECS) (step S416).

Further, the wireless communication device 10 adds the location of the transmission pointer (step S417), and if no transfer data remains (step S418) and if addition of junction data is required (step S419), returns the transmission pointer to the start of the transmission data buffer 102 (step S420), and the process returns to step S412. In addition, the process returns to step S412 even in a case where remaining transfer data is present, and the wireless communication device 10 adds transfer data information elements including remaining transfer data to beacons until the maximum permissible beacon length is reached. The wireless communication device 10 ends the data structuring subroutine even in a case where the beacon reaches the maximum permissible beacon length or in a case where addition of junction data is not required.

On the other hand, if a beacon skip is performed in the next beacon period, the wireless communication device 10 determines whether to transmit the transfer data using the data transfer region as normal data (step S421). Then, in a case of transmission as normal data, the wireless communication device 10 generates a data frame as normal data (step S422) and specifies the counterpart wireless communication device by a transmission indication information element (TIM IE) of the device itself (step S423). Further, the wireless communication device 10 specifies a slot (MAS) for transmission as required (step S424).

4. Conclusion

As described above, in the present embodiment, communication can be performed using an empty portion of periodically exchanged beacons in a wireless communication system. Accordingly, by equipping one device with the necessary configuration for operation with one wireless communication system, it becomes possible to transmit information transmitted using the beacons of the wireless communication system from another wireless communication system. As a result, the need is eliminated to equip one device with a configuration for operating with for example both a wireless communication system for data-transfer use and a wireless communication system for remote-controller use.

Further, because the wireless communication device 10 according to the present embodiment uses periodically exchanged beacons, and so a wireless communication route of a stable bit rate can be obtained for transfer data or commands of a specified information quantity or less.

Further, in a case where competition for use of a beacon slot occurs, the wireless communication device 10 can secure reliability of data transfer in which it is possible to avoid competition by using a predetermined competition avoidance mechanism.

Further, because the wireless communication device 10 according to the present embodiment transmits a beacon in a beacon slot that has already been reserved, processing for prior reservation can be simplified. That is to say, according to the present embodiment, latency time relation to connection setup required in a case of performing data transfer in the data transfer region does not necessarily have to be taken into account.

Further, the wireless communication device 10 according to the present embodiment can determine the reception status of a beacon at a counterpart wireless communication device based on the beacon period occupancy information element included in the beacon transmitted from the counterpart wireless communication device. Accordingly, in the present embodiment, exchange of an explicit receipt confirmation (ACK information) does not necessarily have to be performed.

Further, in the present embodiment, in a case where ample free space exists in the amount of information that can be added to the beacon, the data transfer information elements are added for example up to the maximum permissible beacon length. That is to say, according to the present embodiment, communication can be performed by efficiently using superfluous resources.

Further, the wireless communication device 10 according to the present embodiment, in addition to an existing frame check sequence, adds to the beacon a frame check sequence information element that is not dependent on the transfer data information element. By using this configuration, in the receiving destination device, the broadcasted normal payload portion and the transfer data information element can be received separately.

That is to say, for other than the receiving destination device of the transfer data information element, the broadcasted normal payload portion alone may be decoded and the transfer data information element does not necessarily have to be decoded, and so the processing load can be lowered.

Further, with the ordinary method, transmission of data is not possible until a reservation is established through a plurality of superframe cycles. However, according to the present embodiment, data can be transmitted without performing a reservation, and processing can be simplified.

In particular, in a case where two wireless communication devices 10 reserve approximately the same transfer capacity in both directions and perform communication, with the ordinary method, both wireless communication devices 10 must perform setting of the reservations. In contrast to this, according to the present embodiment, an advantage exists in that by adding a transfer data information element to a beacon, complex bidirectional reservation processing does not necessarily have to be performed.

Further, according to the present embodiment, because it is possible to perform data transfer in the beacon period, the wireless communication device 10 that has changed from a hibernating state to an operating state can change to the hibernation mode immediately after the end of the beacon period, and so electrical power consumption can be reduced.

It should be understood by those skilled in the art that various modifications, combinations, sub-combinations, and alterations may occur depending on design requirements and other factors insofar as they are within the scope of the appended claims or the equivalents thereof.

For example, each step performed by the wireless communication device 10 described in this specification does not have to be performed in time series in line with the order detailed in the sequence diagrams or the flowcharts. Instead, for example, each step performed by the wireless communication device 10 may include processing that is performed in parallel or individually (for example, parallel processing or object oriented processing).

Note that a computer program can also be created that causes hardware such as a CPU, a ROM, and a RAM that are built in to the wireless communication device 10 to perform functions that are the same as each structural element of the above-described wireless communication devices 10. A storage medium that stores the computer program is also provided. If each function block shown by the functional block diagram in FIG. 8 is structured by hardware, a series of processes can be realized by hardware.

The present application contains subject matter related to that disclosed in Japanese Priority Patent Application JP 2008-208949 filed in the Japan Patent Office on Aug. 14, 2008, the entire content of which is hereby incorporated by reference.

What is claimed is:

1. A wireless communication device, comprising:
a communication portion that periodically transmits management information for forming a wireless network with at least one wireless communication device;
a determination portion that determines, based on one of an attribute and a supply speed of information supplied from a given device, whether to add the information to the management information; and
a generation portion that adds the information to the management information according to a determination result of the determination portion.

2. The wireless communication device according to claim 1,
wherein the determination portion determines to add the information supplied from the given device to the management information in a case where the supply speed is less than a specified speed.

3. The wireless communication device according to claim 2,
wherein the generation portion writes the address of a specific wireless communication device in the information supplied from the given device.

4. The wireless communication device according to claim 3,
wherein the generation portion discretely adds an error-detection code of the management information and an error-detection code of the information supplied from the given device.

5. The wireless communication device according to claim 4,
wherein the communication portion receives from the specific wireless communication device the management information indicating whether correct reception was performed by the specific wireless communication device; and
in a case where the management information received from the specific wireless communication device by the communication portion indicates that correct reception by the specific wireless communication device was not performed, the generation portion again adds already-sent information supplied from the given device to the management information.

6. The wireless communication device according to claim 2,
wherein a unit period, including a first period and a second period in which the management information is transmitted by the communication portion, is periodically repeated; and
the communication portion transmits, in the first period, the information supplied from the given device, in a unit period in which the communication portion does not transmit the management information in the second period.

7. The wireless communication device according to claim 2,
wherein a unit period, including a first period and a second period in which the management information is transmitted by the communication portion, is periodically repeated; and
in a case where the communication portion does not transmit the management information in the second period in a specific unit period, the communication portion transmits the management information to which the information supplied from the given device has been added, in the second period in the unit period following the specific unit period.

8. The wireless communication device according to claim 3, further comprising:
a management portion that manages whether the specific wireless communication device is in an operating state or a hibernating state based on the management information received from the specific wireless communication device by the communication portion; wherein
the communication portion transmits, in a period in which the specific wireless communication device is in an operating state, the management information to which the information supplied from the given device has been added.

9. The wireless communication device according to claim 1,
wherein the determination portion determines to add the information supplied from the given device to the management information in a case where an attribute of the information is one of text information, voice information, and audio information.

10. A wireless communication method, comprising the steps of:
periodically transmitting management information for forming a wireless network with at least one wireless communication device;
determining, based on one of an attribute and a supply speed of information supplied from a given device, whether to add the information to the management information; and
adding the information to the management information according to a result of the determination.

11. A program that comprises instructions that command a computer to function as:
a communication portion that periodically transmits management information for forming a wireless network with at least one wireless communication device;
a determination portion that determines, based on one of an attribute and a supply speed of information supplied from a given device, whether to add the information to the management information; and
a generation portion that adds the information to the management information according to a determination result of the determination portion.

12. A wireless communication system, comprising
a plurality of wireless communication devices each having:
a communication portion that periodically transmits management information for forming a wireless network with at least one wireless communication device;
a determination portion that determines, based on one of an attribute and a supply speed of information supplied from a given device, whether to add the information to the management information; and
a generation portion that adds the information to the management information according to a determination result of the determination portion.
